(19) United States
(12) Patent Application Publication
(10) Pub. No.: US 2017/0021999 A1
(43) Pub. Date: Jan. 26, 2017

(54) INTER-MODAL SHIPPING MINI-CONTAINERS AND METHOD OF USING SAME

(71) Applicant: WILLIAM PAWLUK, CALGARY (CA)

(72) Inventor: WILLIAM PAWLUK, CALGARY (CA)

(21) Appl. No.: 15/151,208

(22) Filed: May 10, 2016

Related U.S. Application Data
(63) Continuation-in-part of application No. 14/777,142, filed on Sep. 15, 2015.
(60) Provisional application No. 61/794,916, filed on Mar. 15, 2013.

(51) Int. Cl. B65D 88/52; B65D 90/00; B64D 9/00; B65G 67/04; B65G 67/60; B65D 88/12; B65G 67/20

(52) U.S. Cl. CPC B65D 88/522; B65D 88/127; B65D 90/0013; B65D 88/526; B65G 67/20; B65G 67/04; B65G 67/603; B64D 9/00

(57) ABSTRACT

A mini-container for inter-modal shipping includes panels forming a pair of oppositely disposed side walls, a front wall, a back wall opposite to said front wall, a floor, and a roof. The side, front and back walls may releasably lock to one another to form an enclosure and unlock from one another. The panels are positionable between an erected-for-use configuration and a collapsed storage configuration. In the storage configuration, the side, front and back panels are stacked lying flat to form a stack of the panels laying on the base. The stack of panels is overlaid with the roof. The erected mini-containers are sized for space efficient loading of an inter-modal mobile transport conveyor such as an automobile carrier, train, ship or plane. In their storage configuration the mini-containers may be carried on the mobile transport conveyors for later use carrying cargo and may be carried in a stack simultaneously with mini-containers carrying cargo. The mini-containers may be sized so as to enclose at least two standard-sized pallets or at least three standard-sized boxes positioned side-by-side and adjacent the base of the mini-container.

### CROSS REFERENCE TO RELATED APPLICATIONS

This application claims priority from U.S. provisional patent application No. 61/794,916 filed Mar. 15, 2013, and entitled Mini-Container, and is a continuation-in-part of the U.S. patent application Ser. No. 14/777,142 entitled Inter-Modal Shipping Mini-Containers and Method of Using Same.

### FIELD

This disclosure relates to the field of containers used for inter-modal shipping and in particular to a method and apparatus for shipping using mini-containers as described herein.

### BACKGROUND

The automotive logistics industry doesn't utilize its transportation assets effectively. Applicant believes that $50 billion is spent every year on inefficient transportation, wasting 8 billion litres of diesel fuel worldwide and leaving something in the order of 40 percent unutilized mileage. Applicant believes that the automotive logistics industry accounts for some of the highest empty load factors in transportation. Currently, conventional automotive inbound and outbound loading means an empty load in one direction. What is needed, and it is one object of the present disclosure to provide, is a system providing for the combination of conventional automotive logistics and non-conventional carrying of dry goods or freight in inter-modal shipping mini-containers so as to reduce or eliminate the current levels of empty loading.

In the prior art, such as seen in U.S. Pat. No. 6,497,541, which issued to Pawluk on Dec. 24, 2002, for a Convertible Vehicle Transporting Trailer, it is known not only to use conventional automobile carrier trailers for shipping automobiles, but also to provide convertible trailers which can carry automobiles and which may be collapsed so as to provide a flat bed trailer when not shipping automobiles. As described by Pawluk, conventional car carriers do not collapse down to become a flat bed trailer for hauling cargo, and so conventionally many times on a return trip a car carrier will be empty. One aspect of the present disclosure is to provide small shipping containers, so-called mini-containers, which fit into the space usually occupied by vehicles on conventional and convertible car carriers so that goods or other cargo may be easily shipped on the car carrier, and not just automobiles, and which may also be used for inter-modal shipping.

As stated in U.S. Pat. No. 5,525,026, which issued Jun. 11, 1996 to DeMonte, which describes a method and apparatus for loading, unloading, storing and/or transporting cargo of irregular shape, such as vehicles nested within a trailer, shipping container or like cargo transport, conventionally the transport of newly manufactured vehicles, such as passenger cars, vans, and small trucks, is carried out using an open framework truck trailer having a series of ramps upon which the vehicles are secured. The height and slope of the ramps are adjusted through the use of hydraulic cylinders in order to load the trailer by driving vehicles over the ramps, and to nest them together when stored on the trailer. An example of one such conventional trailer is described in U.S. Pat. No. 4,106,805 to Harold issued Aug. 15, 1978.

According to Harold, the development of conventional trailers has reached a complexity where all vehicle supporting ramps move up and down, and may extend and retract, through a limited range and require the provision of complex and costly system of permanently trailer-mounted hydraulic rams for each ramp. In practical terms the costs, complexity of fabrication, difficulty of maintenance and operation have done nothing to address the basic limitations of such trailers. Conventional auto-transport highway semi-trailers also retain the costly limitation of being unsuitable for transporting any cargo but vehicles. Adaptability to transport different vehicle types and sizes remains limited.

DeMonte describes that due to differences in the profiles of vehicles, such automobile carrier trailers rapidly become obsolete since in practice a trailer is limited in capacity to a narrow range of vehicles which may be accommodated. A trailer is often limited to hauling the vehicles of one manufacturer only. Even of that single manufacturer's products, to accommodate vans and cars a different trailer configuration is used.

According to DeMonte, in loading and unloading the trailers, a high degree of skill is required in properly positioning the ramps, and in driving the vehicles within the very confined space of the trailer's interior. Damage to vehicles is common, resulting in cost increases and delays in delivery.

DeMonte notes that a distinct disadvantage of such trailers is that after vehicles have been unloaded, the trailer must generally return empty since it is ill-suited to transport any cargo other than vehicles.

DeMonte continues, stating that in transporting vehicles by rail, vehicles must also be driven on and off rail cars within confined spaces, and the vehicles are secured on horizontal fixed platforms which do not allow for nesting of the vehicles. As a result, there is a large portion of unused space within rail cars.

DeMonte states that the use of containers to ship vehicles would significantly improve the timing, security and costs of shipping compared to current methods which require frequent repositioning of vehicles between rail, sea, and land transport modes. Inserting vehicles into containers at the manufacturing plant and shipping to a dealer continuously supported on and/or contained in a prospective shipping pallet or container would reduce costs as proven in respect of other cargo, and would eliminate much of the damage to and soiling of new vehicles presently experienced. To date however according to DeMonte no such method has found commercial acceptance.

One object of this disclosure is to provide an inter-modal, dry, mini-container, smaller in volume than that of DeMonte, for shipping cargo in smaller amounts to allow for reducing empty loading in the shipping space ordinarily occupied by automobiles being transported. Another object, of several, is to provide an improved multi-modal freight transportation system employing such mini-containers to transport many types of smaller cargo, and wherein the mini-containers are not limited to being carried on or in any one type of mobile freight transportation conveyor, such as conventional flatbed trailers, automobile carrying trailers, railway cars, container ships, aircraft, etc.

Manufacturers in the automobile industry, and other industries, use standardized sizes of pallets and boxes for shipping their goods worldwide. For example, without intending to be limiting, in the automobile industry boxes that have a length of 1200 mm and a width of 800 mm, and pallets that have a length of 1200 mm and a width of 1000 mm are amongst the most common dimensions of pallets presently used in Europe and around the world in the automotive manufacturing industry and other industries. Other standardized sizes of pallets are adopted widely in the automotive and other manufacturing industries; for example, in North America, the use of pallets with a length of 1219.2 mm, a width of 1143 mm, having for example a finished load height of 1320.8 mm (48″×45″, load height of 52″) are also common. The above examples of standardized dimensions presently used by industry are provided for illustration purposes only and are not intended to be limiting. As well, additional standardized dimensions for pallets, boxes or other shipping containers may be adopted by industry in the future.

However, it is often difficult, if not impossible, to maximize the loading capacity of a trailer, automobile carrier or other flat deck transportation vehicle that is to be loaded with pallets or smaller boxes. In the usual course of shipping goods on a pallet, the goods are stacked onto the pallet and then the stack of goods is secured by plastic film, sometimes referred to as “pallet wrap”. Thus, pallets often cannot be stacked on top of each other during transport, due to the potential unevenness of the upper surface of a load of goods secured to a pallet by pallet wrap which is unlikely to provide a flat and stable base for a load to be stacked on top of the palletized load.

Goods secured to a pallet with pallet wrap are also substantially unprotected from any forces that would be transmitted to the goods if a load were to be stacked on top, thereby potentially damaging the goods secured to the pallet. Similarly, with respect to the standardized boxes mentioned above, such boxes are often constructed of cardboard with limited load bearing capacity, which limits the extent to which the cardboard boxes may be stacked on top of each other during transport. Furthermore, it is generally less efficient to load or unload a large number of small boxes or pallets onto or off of a vehicle, as compared to loading or unloading a smaller number of containers which each contain at least two or more boxes or pallets. Thus, the space available in, for example, a trailer or a flat bed, for transportation of goods is restricted by the problems associated with stacking wrapped pallets or boxes within the trailer, often limiting such trailer loads to a single layer of pallets or smaller boxes and rendering the space above the pallets or boxes unused.

Furthermore, it is often impractical to transport a load of wrapped pallets or cardboard boxes on a flat bed trailer or empty vehicle carrier, for example, as there is often insufficient protection from wind, snow, rain and dirt for the goods being transported on pallets or in cardboard boxes. It is therefore a further object of the present disclosure to provide an inter-modal, dry, mini-container that is sized so as to receive and enclose multiple boxes or pallets of the dimensions specified above, so as to maximize the amount of space for loading goods on a trailer, flat bed or other transport vehicle by enabling the stacking of mini-containers enclosing pallets or boxes loaded with goods.

In addition, so as to facilitate decreasing the number of empty loads carried by automobile carriers or other types of freight carriers, it is an object of the present disclosure to provide a standardized sizing for collapsible, inter-modal mini-containers that may be pooled amongst various different shipping carriers so as to provide better availability of empty mini-containers ready for loading or re-loading with new cargo at various transportation hubs for a given automobile carrier or carrier of other types of freight.

A further potential issue with present freight containers available to the manufacturing industry is that such freight containers have substantially flat surfaces on the bottom of the container. When these freight containers are stacked on top of each other during transport, sudden forces acting on the stacked containers may cause containers stacked on top of other containers to shift, which may cause the upper containers to fall off of the containers below, thereby increasing the potential damage to the contents of the containers that shift during transport. For example, a freight truck that suddenly brakes while travelling at a high speed while carrying a load of stacked shipment or freight containers may cause the upper containers stacked on lower containers to continue moving in a forward direction due to the momentum acting on those upper containers if there is insufficient friction between the bottom surface of the upper containers and the top surface of the lower containers upon which the upper containers are stacked. Also, the stability of a stack of containers during transport partially depends on properly aligning the upper containers stacked on top of other containers so as to maximize the contact between the bottom surface of the upper container and the upper surface of the container below. If the stacked containers are not properly aligned, a sudden force acting on an upper container may cause the maligned upper container to slide completely off of the lower container, again potentially causing damage to the contents of the fallen container. A further object of this disclosure is therefore to provide for a standardized corner locating and locking system to better stabilize containers stacked on top of other containers.

### SUMMARY

What is neither taught nor suggested by the prior art, including by DeMonte in his U.S. Pat. No. 5,525,026, is the use of small containers, referred to herein as mini-containers, which are too small to carry conventional automobiles, for carrying cargo in or on mobile transport conveyors such as conventional automobile transport semi-trailers, convertible trailers, and other trailers, intermodal containers, railcars, ships, airplanes, etc., so as to allow both mixed and unmixed loads of such mini-containers and automobiles or other cargo for increased efficiency of use of such mobile transport conveyors and other transport means in the chain-of-transport.

The mini-containers may be modular in the sense that they may advantageously be disassembled, de-constructed, dis-mantled or folded down for compact storage, for example by stacking, thereby allowing them to be carried, for example, on the trailer, railcar, etc., until needed, and thereby remain available to be quickly erected for use, for example for loading or unloading by a conventional forklift.

In applicant's view, the useful, space-efficient sizing; that is, not just the making small, of the mini-containers, provides a flexibility of use not found in any present form of transporting cargo. DeMonte thought it was useful to put automobiles in containers. By necessity this means that these containers were large. Although the containers of DeMonte may be not as big as ocean-going full-size containers, the DeMonte containers are still too large to provide for flexible types of loading as provided by the present disclosure. If appropriately sized and appropriately used as described herein, mini-containers increase the efficiency of use of the space provided in a number of different types of mobile transport conveyors. Examples are given below which are not intended to be limiting.

One example of this is the above mentioned car-carrier prior art, which conventionally carries automobiles on an out-going leg of a trip, but because of the unique nature of the trailer it is not adapted to carrying other types of loads on the return trip. Using mini-containers which are sized to fit somewhat snugly across the lateral available width of the car-carrier trailer, and which have a height so that the mini-containers may be stacked for example two or three high, again to fit somewhat snugly within the vertical space available, allows for efficient cargo-carrying return trips and for mixing outbound or in-bound cargo to include both mini-containers and automobiles or other bulky cargo in a mixed combination.

In summary, the disclosure may be characterized in one aspect as including a mini-container for intermodal shipping having panels forming a pair of oppositely disposed side walls, a front wall, a back wall opposite to said front wall, a base, and a roof. The side, front and back walls releasably lock to one another to form an enclosure and unlock from one another so as to release one another for positioning of the panels between an erected-for-use configuration and a collapsed storage configuration. In the storage configuration the side, front and back walls are stacked, advantageously lying flat to form a stack of the panels laying on the base. The stack of panels is overlaid with the roof.

In another embodiment, the base of the mini-container comprises a plurality of feet protruding from the base, and the roof comprises a corresponding plurality of cups recessed into the roof, wherein the plurality of feet on a base of a first mini-container couples with the corresponding plurality of cups on a roof of a second mini-container when the base of the first mini-container is stacked on top of and adjacent to the roof of the second mini-container. In a further embodiment, the plurality of feet comprises at least one foot located proximal a corner of the base and the plurality of cups comprises at least one cup located proximal a corner of the roof, wherein the corner of the base of a first mini-container is adjacent the corner of the roof of a second mini-container when the base of the first mini-container is stacked on top of and adjacent to the roof of the second mini-container. In still a further embodiment, each foot of the plurality of feet and each cup of the corresponding plurality of cups has frustoconical geometry.

According to a further aspect of the disclosure, the method of intermodal shipping using the mini-containers described above includes:
a) providing a plurality of the mini-containers, wherein each mini-container is assembled from the panels so as to form the aforesaid pair of oppositely disposed side walls, front wall, back wall opposite to the front wall, a base, and a roof. Advantageously the side, front and back wall panels are assembled so as to be contiguous to one another when in their erected-for-use configuration, so as to form an enclosure of the mini-container. The panels disassemble from one another for positioning from the erected-for-use configuration into their collapsed storage configuration,
b) providing a mobile transport conveyor having at least one loading bed, wherein said mobile conveyor transport is chosen from the group comprising: a trailer, an automobile transport trailer, a convertible transport trailer, a flatbed trailer, an enclosed van trailer, a curtain-side trailer, a flatbed railwaycar, an enclosed railwaycar, a ship, a barge, an airplane,
c) constructing each mini-container into its erected-for-use configuration, and storing cargo in the enclosures of a plurality of the constructed mini-containers,
d) once the cargo is stored in the plurality of mini containers, then loading the plurality of mini-containers on to the mobile transport conveyor, for example by using a forklift.

Also, in a further embodiment of the method described above, each mini-container has an in-use length dimension and an in-use width dimension, and when the mini-container is in the erected-for-use configuration, the in-use length and width dimensions are sized so as to contain at least two pallets or at least three boxes enclosed by the mini-container, when the at least two pallets or at least three boxes are positioned side-by-side and adjacent the base of the mini-container. Further, each pallet of the at least two pallets have a length of substantially 1200 mm and a width of substantially 1000 mm, or as another example of standardized pallet dimensions, each pallet of the at least two pallets have a length of substantially 1219.2 mm (48 inches) and a width of substantially 1143 mm (45 inches). Alternatively, each box of the at least three boxes have a length of substantially 1200 mm and a width of substantially 800 mm.

A person skilled in the art will understand that the mini-containers in this disclosure may be adapted so as to receive and enclose a multiple of pallets or boxes of standardized dimensions commonly used in the industry around the world, including presently adopted standardized dimensions as well as standardized dimensions that may be adopted in the future, and that the present disclosure is not limited to the examples of standardized dimensions of pallets, boxes and mini-containers stated above, which examples are provided for illustration purposes only and are not intended to be limiting.

### BRIEF DESCRIPTION OF THE DRAWINGS

In the drawings where a like reference numerals denote corresponding parts in each view:

FIG. 1 is, in rear perspective view, an assembled mini-container according to one embodiment.

FIG. 1a is a cross-sectional view along line 1a-1a in FIG. 1.

FIG. 1b is, in perspective view, the mini-container of FIG. 1 being lifted by a fork-lift.

FIG. 1c is, in front perspective view, the mini-container of FIG. 1, with the lifting lugs elevated.

FIG. 2a is, in perspective view, the base of the mini-container of FIG. 1. FIG. 2b is, in bottom perspective view, the base of FIG. 2a.

FIG. 2c is, in side elevation view, an enlarged partially cut-away corner of the base of FIG. 2a.

FIG. 3 is, in partially cut away, partially exploded view, the interlocking of hard points between two vertically stacked mini-containers.

FIG. 4a is, in top perspective view, the roof of the mini-container of FIG. 1.

FIG. 4b is, in bottom perspective view, the roof of FIG. 4a.

FIG. 5 is, in front perspective view, an alternative embodiment of the mini-container of FIG. 1, partially cut-away and with the roof removed.

FIG. 5a is an enlarged view of a portion of FIG. 5 showing the interlocked upper corners of adjacent panels of the mini-container of FIG. 5.

FIG. 5b is, in rear elevation view, an enlarged portion of the view of FIG. 5a.

FIG. 5c is, in front perspective, partially cut-away view, the upper corners of the adjacent panels of the mini-container of FIG. 5 with the latch unlocked and the narrow panel partially pivoted away from the long panel.

FIG. 6a-6h are, in front perspective view, a sequence of views showing the collapsing of the mini-container of FIG. 1 from its erected-for-use configuration to its storage configuration by the folding down of the side panels onto the base.

FIG. 7 is, in side elevation view, the fully collapsed mini-container of FIG. 6h with the roof mounted down onto the base so as to enclose the folded down side panels.

FIG. 8 is, in perspective view, a stack of four of the mini-containers of FIG. 6h, ready for transportation, deployment or storage.

FIG. 9a is, in rear perspective view, a tractor and convertible car-carrier trailer combination showing the trailer in a flat-bed configuration and have a plurality of the mini-containers of FIG. 1, partially cut-away, loaded thereon, wherein a variety of cargo is shown loaded in the mini-containers.

FIG. 9b is, in side elevation, the tractor and loaded trailer of FIG. 9a.

FIG. 9c is the view of FIG. 9b, with the mini-containers on the elevated front deck of the trailer replaced with a stack of mini-containers in their collapsed, storage configuration.

FIG. 9d is the tractor and convertible trailer of FIG. 9a with the trailer in its car-carrier mode and carrying a mixed load of cars and cargo-carrying mini-containers.

FIG. 10a is, in perspective view, a railway car having a plurality of the mini-containers of FIG. 1 loaded therein.

FIG. 10b is the railway car of FIG. 10 wherein the railway car is loaded with a combination of mini-containers and automobiles.

FIG. 10c is, in side elevation view, a railway car being loaded with mini-containers from one end of the railway car.

FIG. 11a is, in perspective view, the interior surface of the long panels of the mini-container of FIG. 1.

FIG. 11b is, in perspective view, the interior surface of the short panels of the mini-container of FIG. 1.

FIG. 12 is, in partially cut-away perspective view, an enlarged section of the hinge of one panel in the mini-container section of FIG. 1a.

FIG. 13 is, in perspective view, one lifting lug of the mini-container of FIG. 1.

FIG. 14 is, in partially cut-away perspective view, an alternative embodiment of the mini-container of FIG. 1 employing over-center latches between the roof and side, front and/or rear panels.

FIG. 15 is in partially cut-away perspective view, a further alternative embodiment of the mini-container of FIG. 1 employing a latching mechanism between the hard-points on adjacent stacked mini-containers.

FIG. 16a is, in perspective view, an embodiment of a locating foot adapted to be attached to, or formed as part of, the base of a mini-container.

FIG. 16b is a cross-sectional front elevation view of a section taken along line A-A of the locating foot illustrated in FIG. 16a.

FIG. 17a is, in perspective view, an embodiment of a receiving cup adapted to be attached to, or formed as part of, the roof of a mini-container.

FIG. 17b is a cross-sectional front elevation view of a section taken along line B-B of the receiving cup illustrated in FIG. 17a.

FIG. 18a is a side elevation view of a base of a mini-container, incorporating the locating feet illustrated in FIGS. 16a and 16b.

FIG. 18b is a bottom elevation view of the base of a mini-container illustrated in FIG. 18a.

FIG. 18c is an expanded view of a portion of FIG. 18a, showing the details of a locating foot coupled to the bottom surface of the base.

FIG. 19 is, in perspective view, an embodiment of a mini-container with the roof and front panel removed, showing two pallets carrying loads enclosed within the mini-container.

### DETAILED DESCRIPTION OF THE EMBODIMENTS:

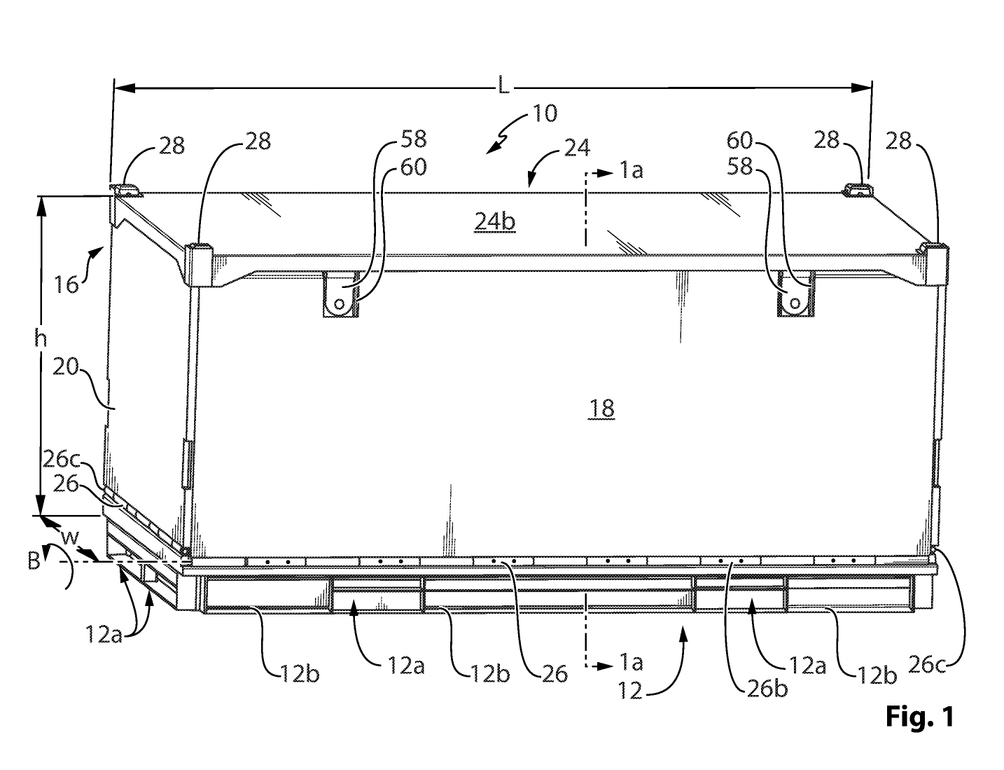

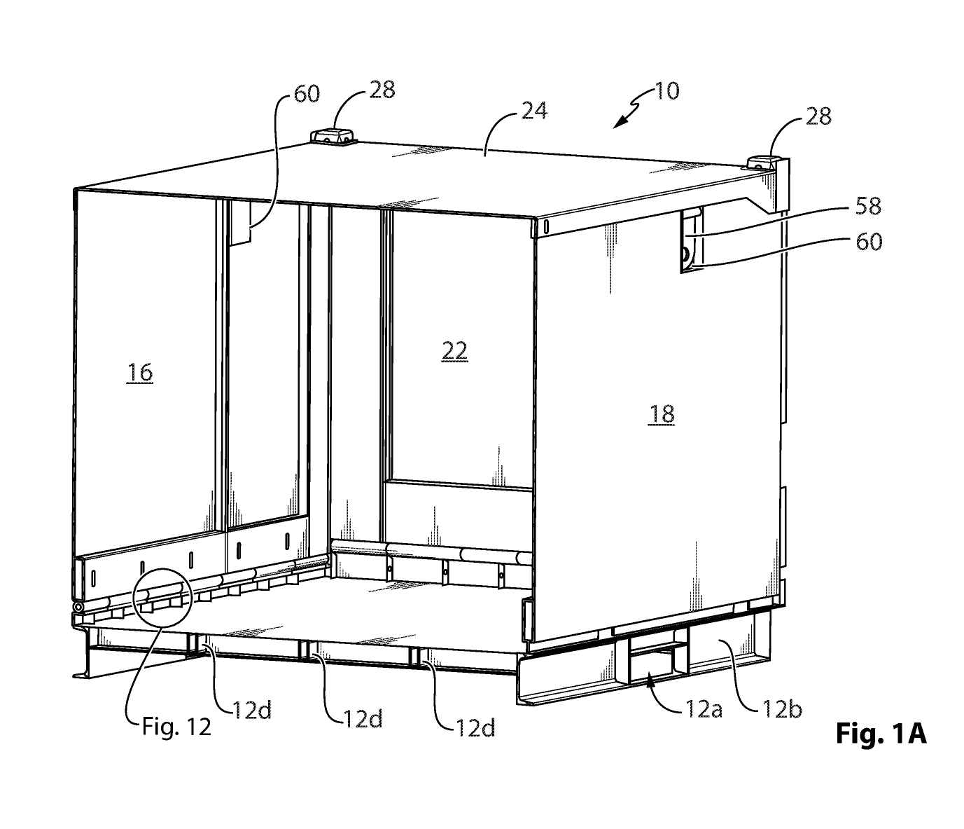

In one embodiment each mini-container 10 has exterior dimensions of for example approximately 1.29 metres wide by 2.55 metres long by 1.24 metres high, labeled respectively in FIG. 1 as width w, length 1, and height h. Preferably mini-container 10 is of collapsible construction. Each mini-container 10 may be of metal or other construction. For example each mini-container 10 may be made of galvanized steel, or other alloys, or of lighter weight metals such as aluminum or titanium, or may be made of plastics, or carbon-fibre, fibre-glass, or other composite materials, or may be made of more conventional materials including wood, or any combination of these.

Each mini-container has interior dimensions smaller than the exterior dimensions mentioned above; for example, interior dimensions that are incrementally less than 1.29 m wide by 2.55 m long by 1.24 m high. In a further embodiment of the present disclosure, the interior dimensions of the mini-container are adapted so as to receive and enclose, for example, multiple standardized pallets or boxes that are commonly used in the manufacturing and shipping industries. For the purposes of illustration only, not intended to be limiting, the interior dimensions of each mini container may be sized so as to accommodate three boxes that are substantially 1200 mm in length and 800 mm in width, or to receive two pallets positioned side-by-side that are each 1200 mm in length and 1000 mm in width. As a further example, not intended to be limiting, the interior dimensions of the mini-container may be 1218 mm in width and 2480 mm in length, which interior dimensions for example would accommodate either three boxes each substantially 1200 mm in length and 800 mm in width, or two pallets each substantially 1200 mm in length and 1000 mm in width.

Alternatively, the mini-containers may be adapted so as to receive and enclose at least three boxes that are substantially 1200 mm in length and 800 mm in width, or to receive two pallets positioned side-by-side that are each 1200 mm in length and 1000 mm in width, or to receive two pallets positioned side-by-side that are each 1219.2 mm (48 inches) in length, 1143 mm (45 inches) in width and having a finished, loaded height of 1320.8 mm (52 inches). A person skilled in the art will understand that the mini-containers may be adapted so as to receive and enclose a multiple of pallets or boxes of standardized dimensions commonly used in the industry around the world, and that the present disclosure is not limited to the examples of standardized dimensions of pallets, boxes and mini-containers stated above, which examples are provided for illustration purposes only and are not intended to be limiting.

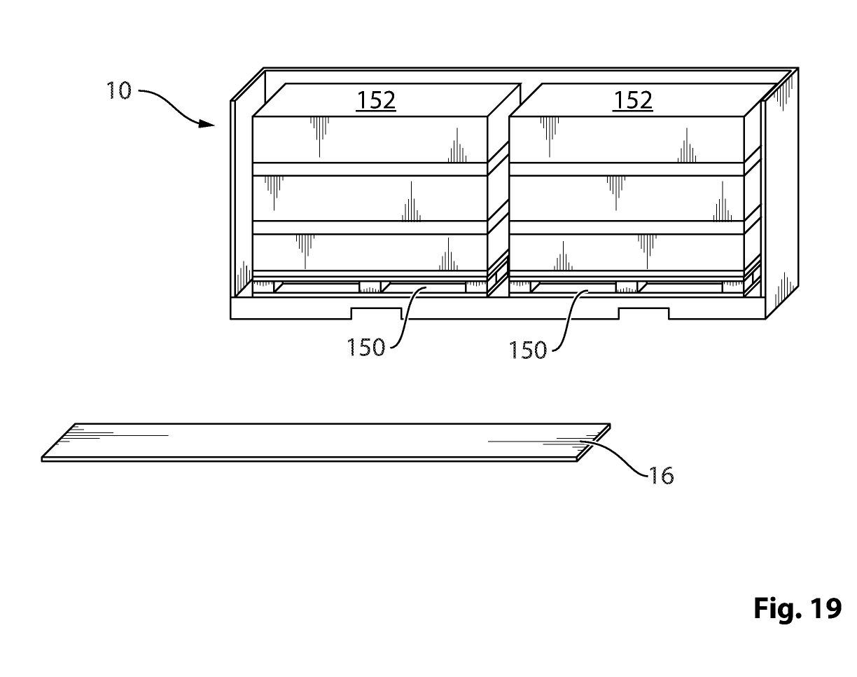

As illustrated in FIG. 19, a mini-container 10 is shown with the front panel 16 and roof 24 removed. Enclosed within the back panel 18, narrow side panels 20, 22 and base 12 are two pallets 150, 150, where each pallet 150 is supporting a load 152, 152. Upon replacing the front panel 16 and roof 24 (not shown) on the mini-container 10, the pallets 150, 150 and the loads 152, 152 will be fully enclosed by the base 12, panels 16, 18, 20, 22 and roof 24 of the mini-container 10.

Each mini-container 10 is preferably built on a palletized base or otherwise includes a base 12 having apertures 12a which are accessible with the forks of a fork truck or fork lift (collectively herein a “fork lift”) 14 from opposite or all sides of the base 12. Advantageously, each mini-container 10 once assembled is substantially water-tight, for example by the use of seals (not shown) between adjacent panels, roof and base as would be known to one skilled in the art, so that each mini-container remains substantially dry inside. Advantageously, when mini-container 10 is collapsed, the size ratio of the outside height dimensions may be for example substantially in the range of 4:1 to 5:1 (erected: collapsed). Thus, in its collapsed storage configuration, for example four or five mini-containers 10 may be stored in the space taken by a single mini-container 10 when erected. For example, the height of a collapsed mini-container 10 may be approximately 26.6 cm. Advantageously, the length to width ratio of a mini-container is substantially 2:1.

Further advantageously, the erected mini-containers 10 should be stackable at least three high when loaded to their maximum weight capacity. The mini-containers may be lockable, for example using a handle, latch or otherwise a lock as herein-before defined. Each mini-container 10 advantageously should be manually manageable by two men when the mini-container is unloaded.

Each mini-container may include lifting points or lugs, and may include stacking legs or feet, and advantageously may have a substantially flush exterior surface on all sides, which nay be used for displaying advertising.

In one embodiment, one side of an erected mini -container 10, for example a long side panel 16, otherwise referred to herein as a front panel, of each mini-container 10 is removable, for example by sliding the front panel laterally along and relative to the base to allow access into the mini-container by a fork lift 14. The forklift may thus be used to load cargo 10a into the enclosure of the mini-container, and then the forklift may be used to move the loaded mini-container 10.

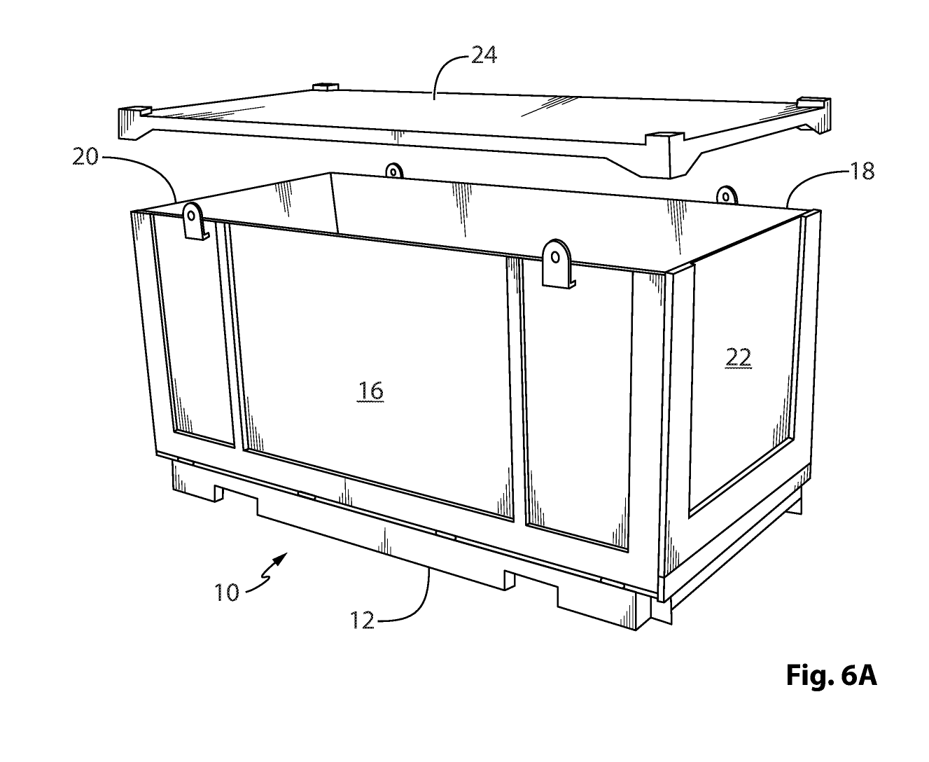

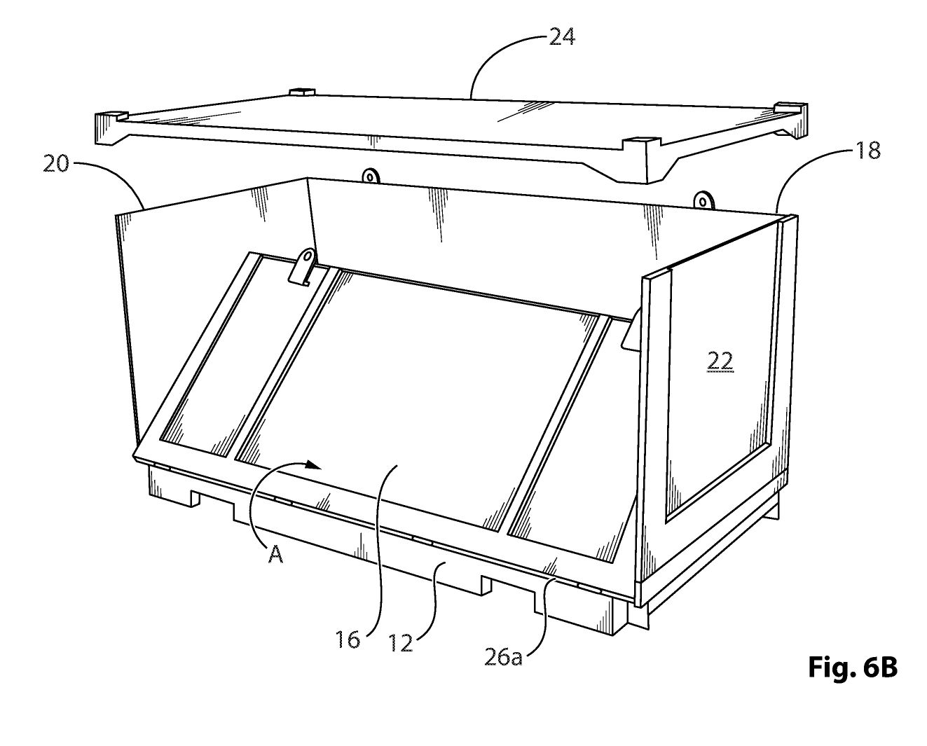

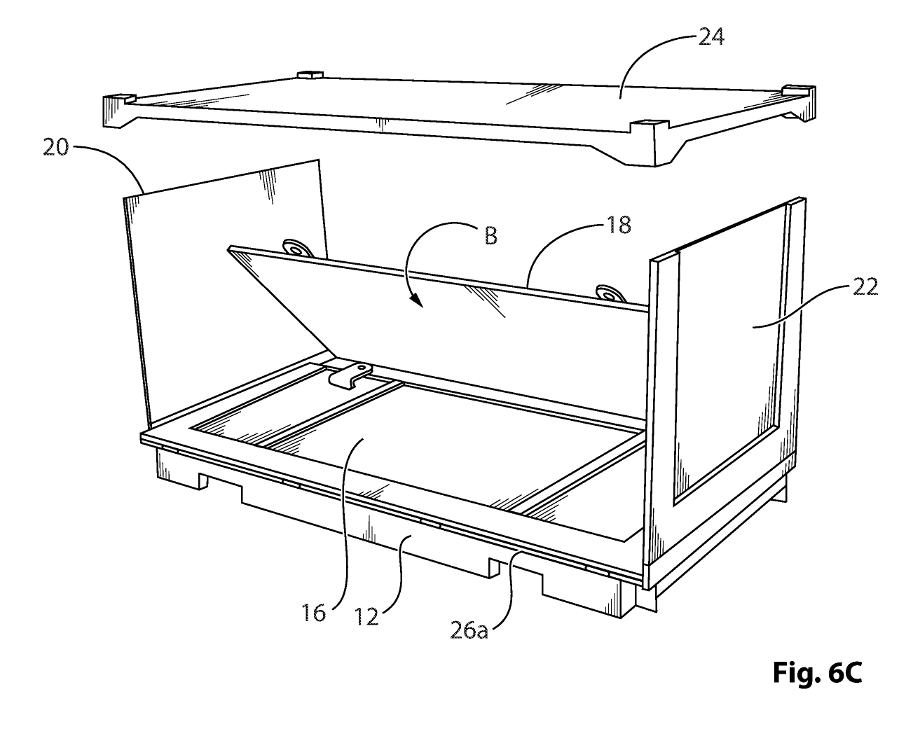

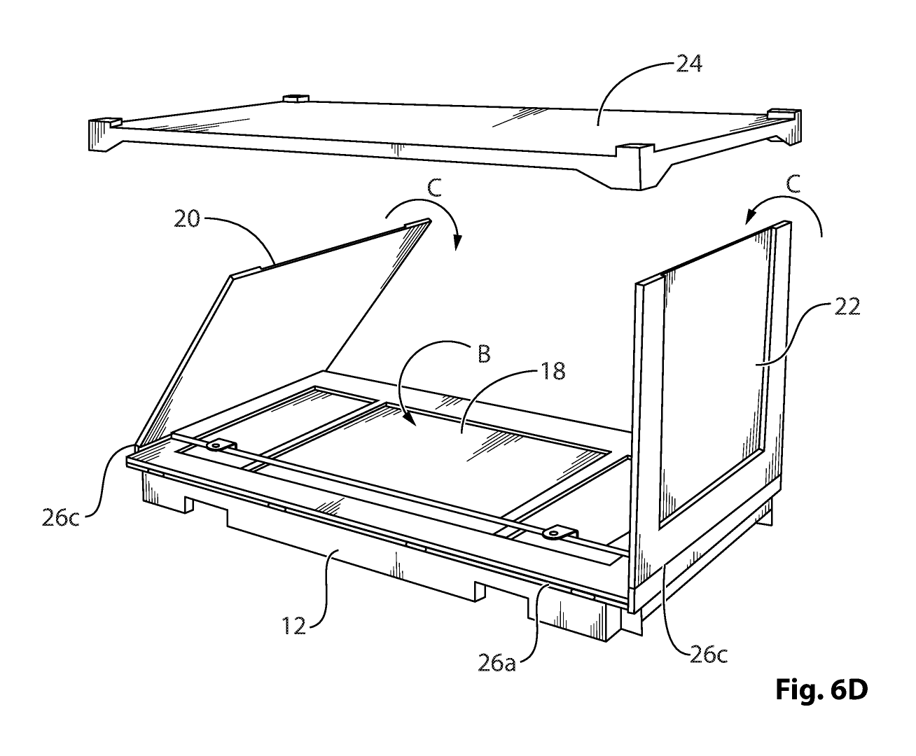

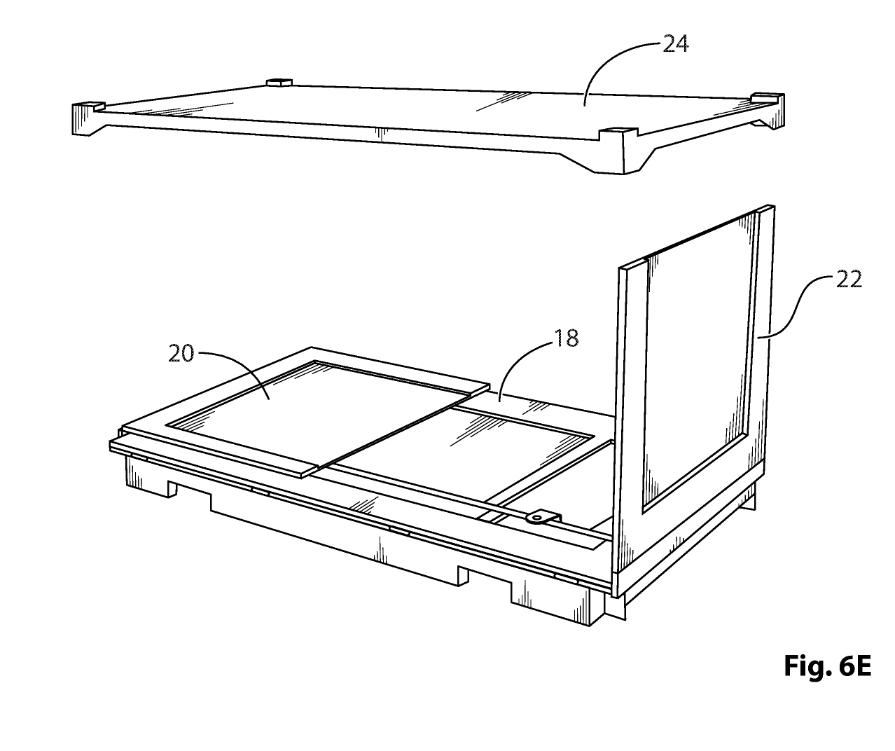

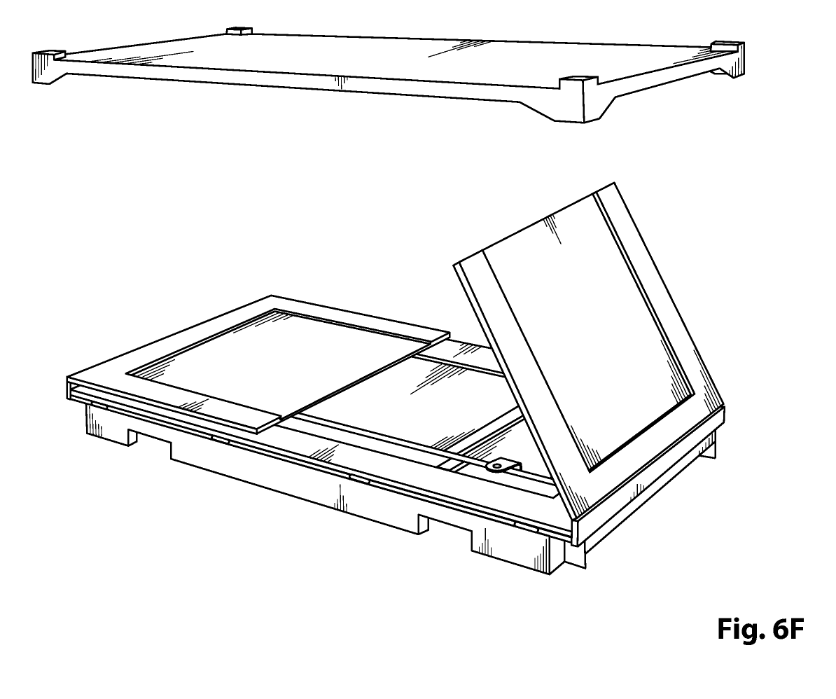

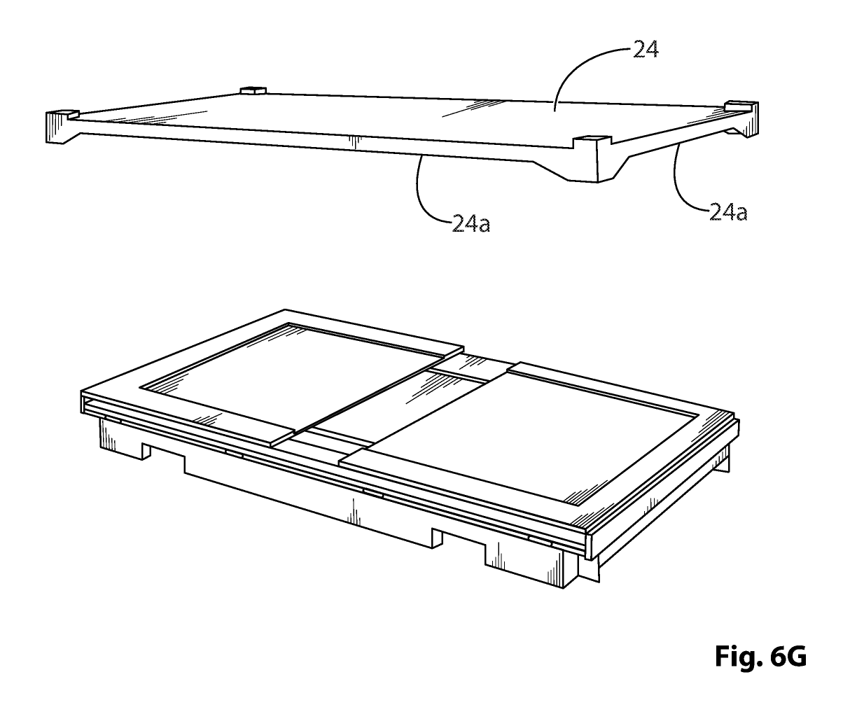

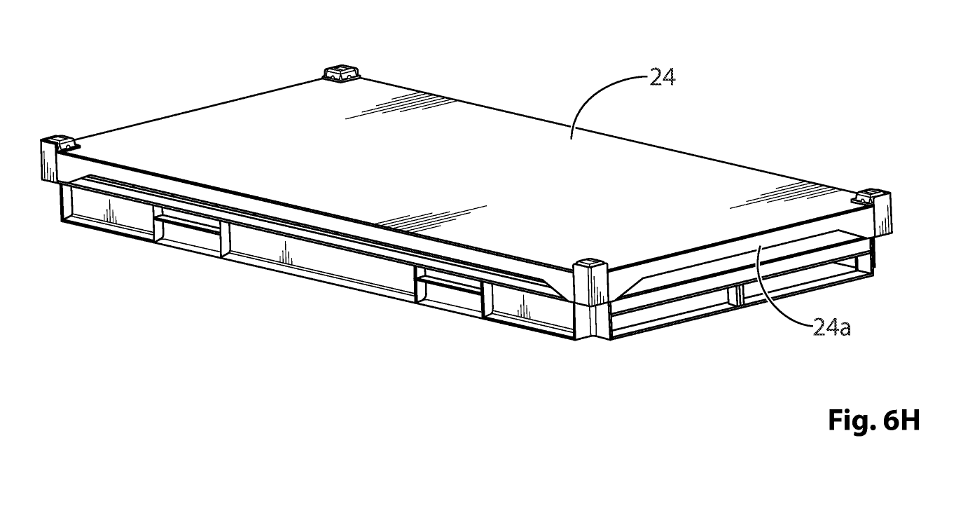

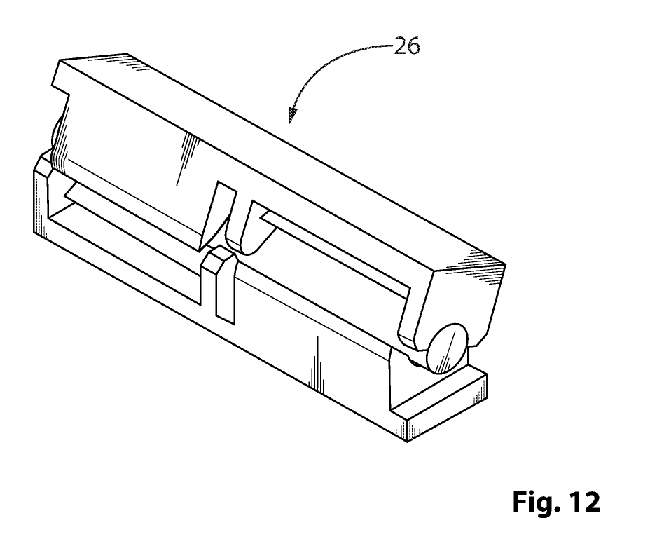

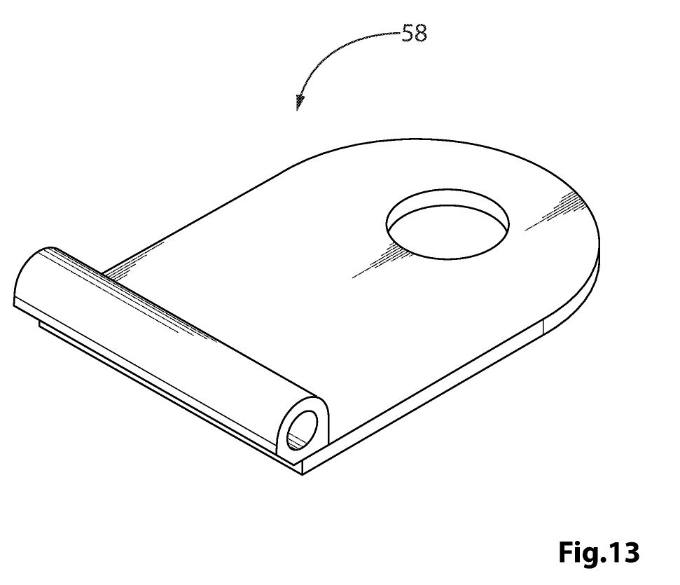

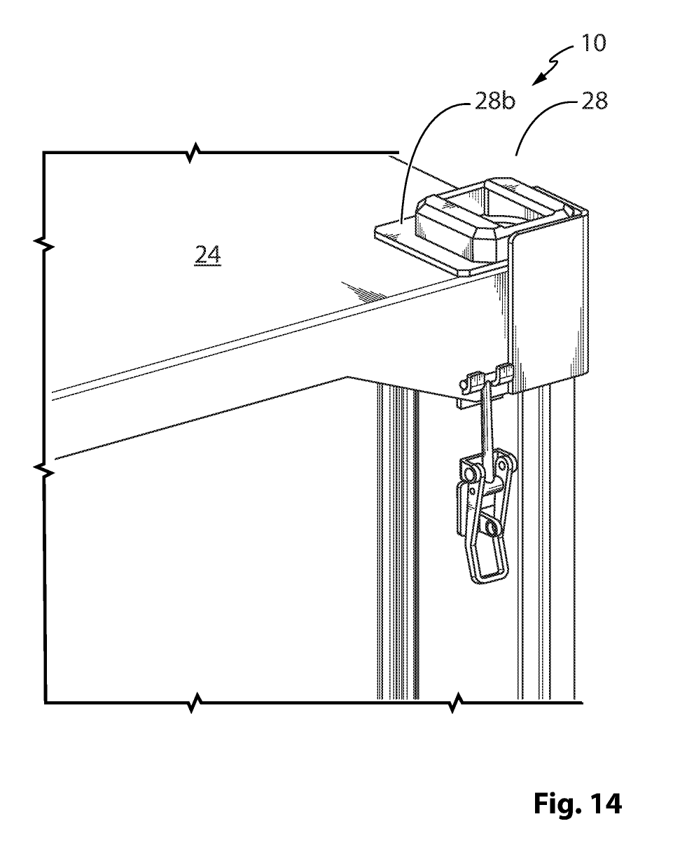

In one embodiment the sides of each mini-container 10 fold in sequence as shown by way of example in FIGS. 6a-6h, about hinges 26 as follows: fold down removable long side panel 16 first, then the opposite long side panel 18 second, then both narrow side panels 20, 22. Once the side panels 20, 22 are folded down, the roof 24 may be placed down onto the stack of folded-down panels. This final collapsed position and arrangement is one example of the storage configuration of the mini-container. In embodiments where roof 24 has circumferential rim 24a depending downwardly there-around, rim 24a may encase panels 16-22 therein when roof 24 is in the storage position. In a preferred embodiment roof 24 locks in the storage position, for example using latches or locks as defined herein by way of example such as the latch of FIG. 14, thereby holding the folded-down panels 16-22 in place on base 12 in a tidy and conveniently small package.

For sake of reference herein and without intending to be limiting, the removable long panel 16 is referred to as the front panel, the opposite long panel 18 is referred to as the back panel, narrow panel 20 is referred to as the right panel, and narrow panel 22 is referred to as the left panel. Each of these panels may be formed differently than as illustrated, as the illustrations are by way of example only.

In certain embodiments castors (not shown) may be provided. The castors mount under the bottom corners of a mini-container 10 and may be removable. Preferably receivers for mounting of the castors under a mini-container 10 are incorporated into the frame of base 12.

Advantageously, when stacked vertically such as shown in FIG. 8 as stack 10b, mini-containers 10 interlock so as to increase the stability of the stacked column of mini-containers. This may be accomplished by providing hard points 28, again illustrated by way of example and not intending to be limiting, that bear the vertical weight of the mini-containers in the stack 10b, so as to relieve bearing loads on mini-container seals. Consequently, each of the four corners of each mini-container 10 advantageously has a metal-on-metal hard point surface to transmit vertical forces into the vertical members 32. Vertical members 32 may be made of hollow tubing or channel, although this is not intended to be limiting, as other rigid elongate members would work.

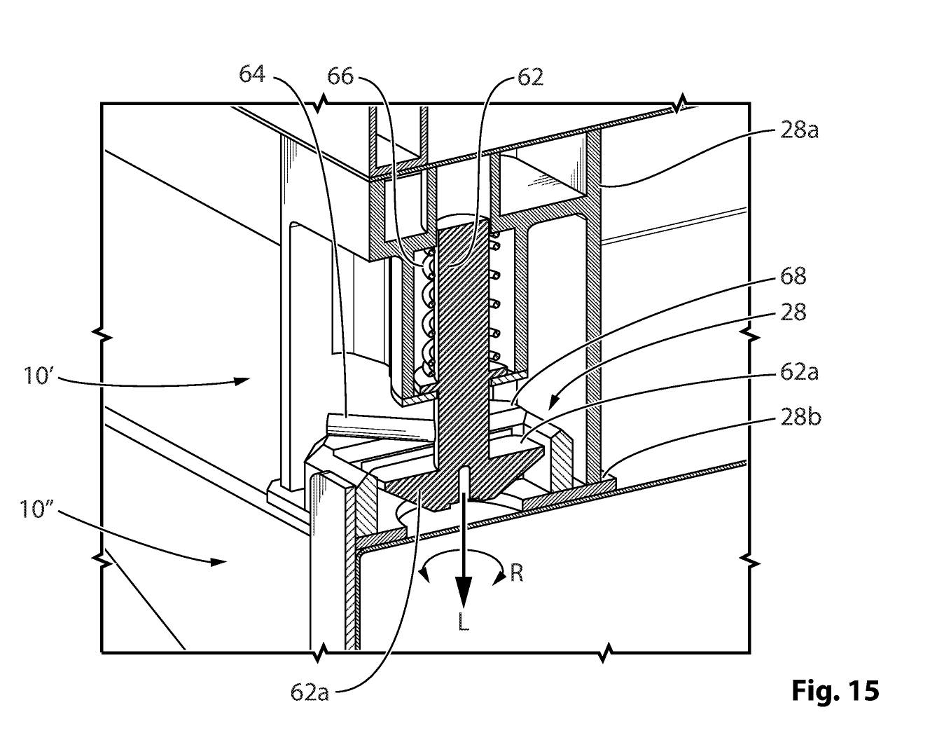

Holes 34 may be provided in the base frame for tie down of the mini-container to the deck of a mobile transport conveyer such as a trailer. Other tie down methods may be used such as those used on conventional Hi Boy and Step Deck trailers, as would be known to those skilled in the art. Locking mechanisms such as shown by way of example in FIG. 15 may also by employed, where for example spring-biased plunger lock 62 may be lowered in direction L using handle 64 against the return biasing force of spring 66 so as to engage locking lugs 62a under locking flanges 68 of hard points 28 by the rotation of plunger lock 62 and lugs 62a in direction R. Lugs 62a may also be used to lock a mini-container 10 down into a deck or bed of a mobile conveyor such as a trailer.

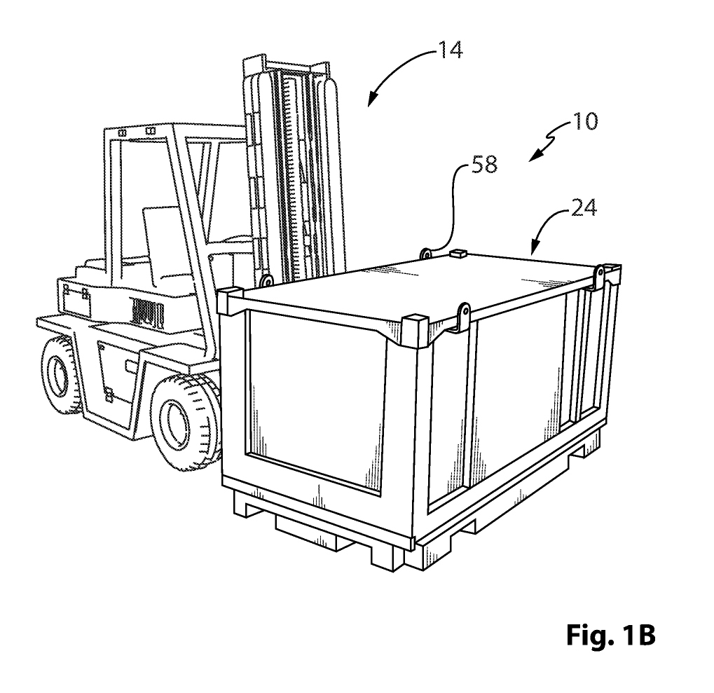

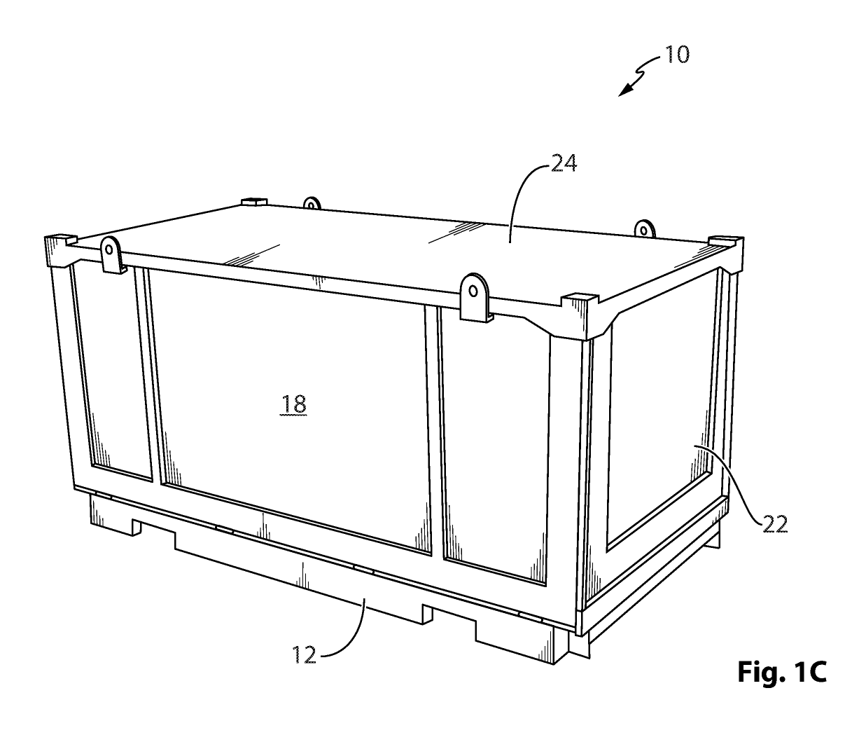

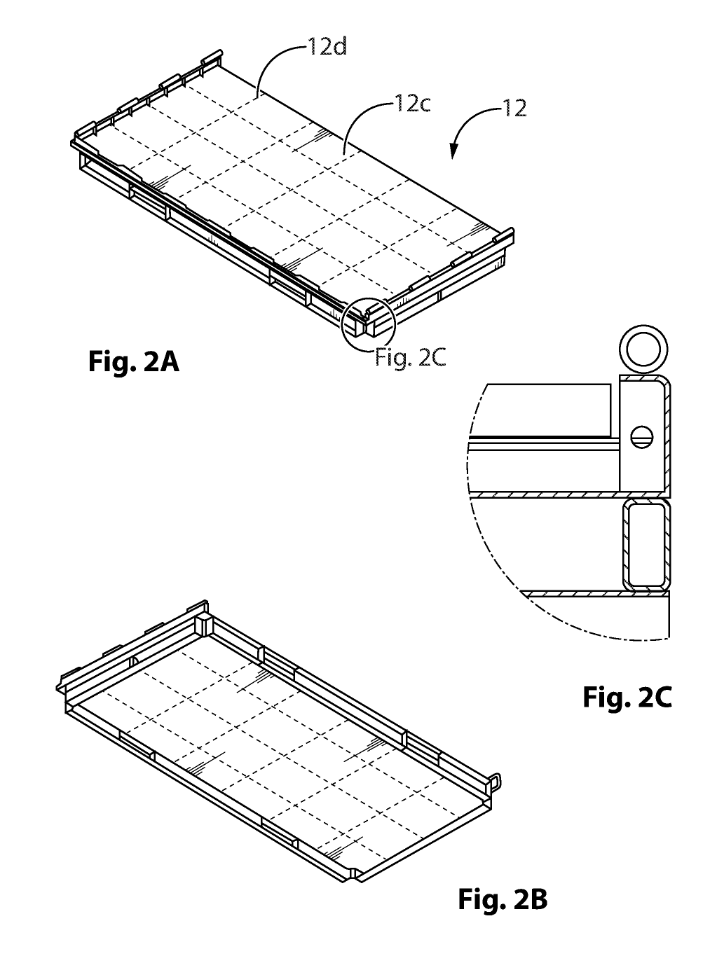

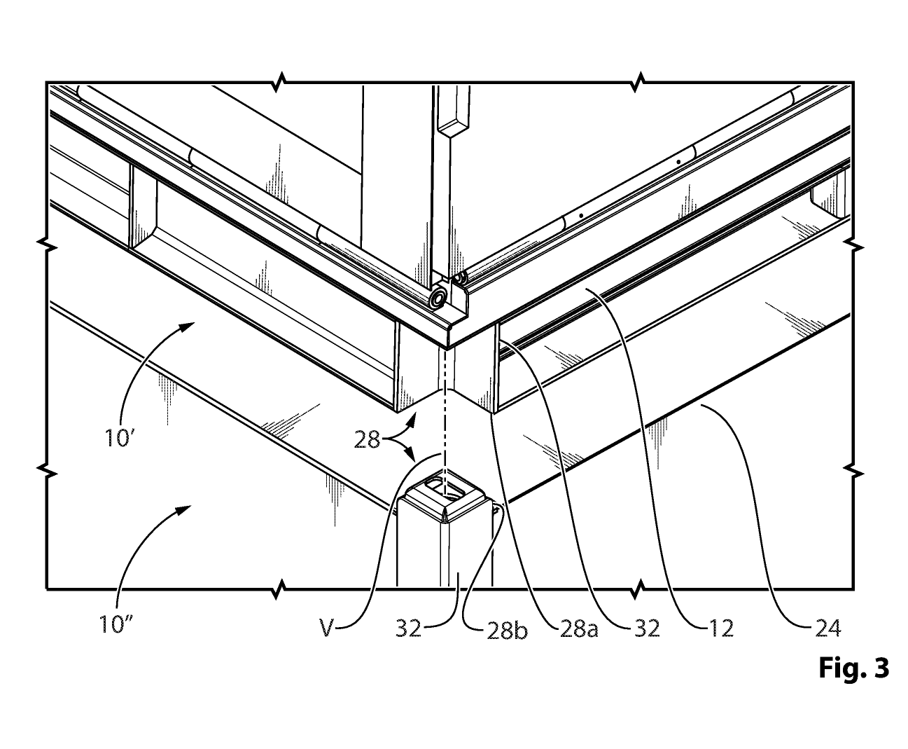

As seen in FIGS. 2a and 2b, base 12 may take a form of a conventional pallet in terms of its function of accepting the forks 14a of a fork lift 14 into pallet apertures 12a. Apertures 12a may thus be formed as pairs of apertures in or between pallet feet 12b. The deck 12c of base 12 may be supported by a lattice structure of stringers or cross members 12d (shown in dotted outline). Hard points 28 may be mounted up underneath or formed as part of, the underside of feet 12b, for example, the feet 12b on the ends or forming the corners of base 12. The interlocking along vertical axis “V” of hard points 28 between vertically stacked adjacent mini-containers 10 is seen in FIG. 3, where the downwardly protruding angle-channel hard point 28a on an upper mini-container 10 engages on, so as to mate with, a corresponding upper surface of hard point 28b mounted on or forming the corresponding upper corner of the lower mini-container 10″.

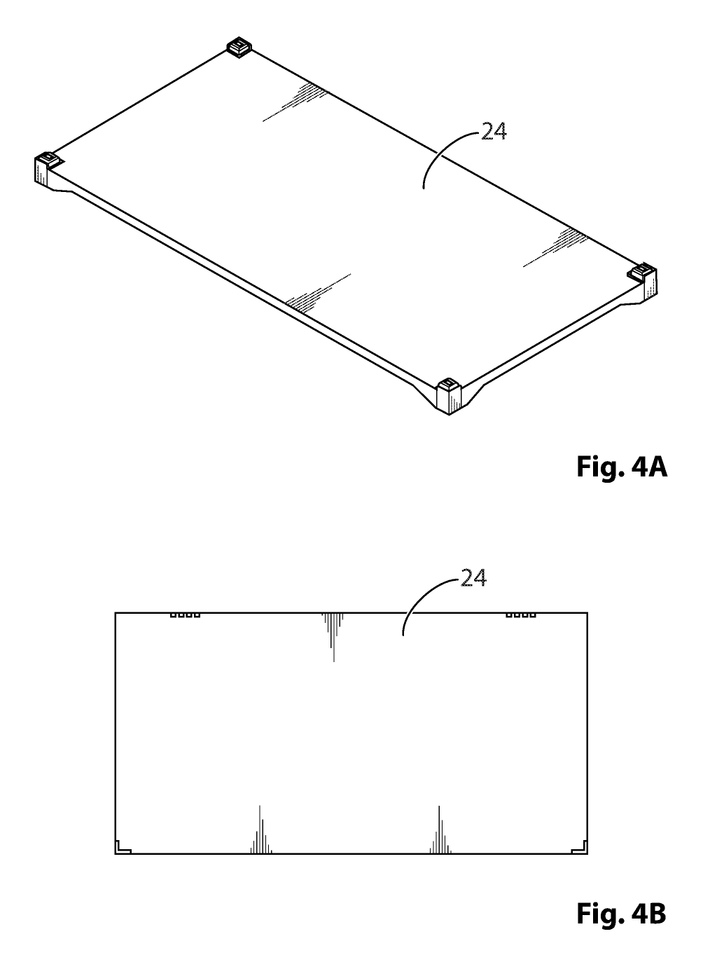

Roof 24, as seen in for example FIGS. 4a and 4b, has circumferential rim 24a which provide a supporting frame for cover 24b. Hard points 28, and in particular hard points 28a and 28b as illustrated, are not intended to be limiting, may also mate male and female couplings (not shown). Hard points 28b may form part of the vertical members 32 which are mounted to the corners of rim 24a.

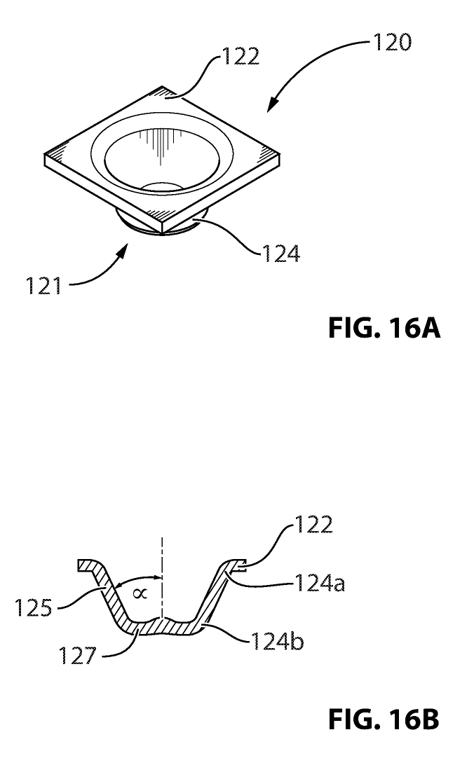

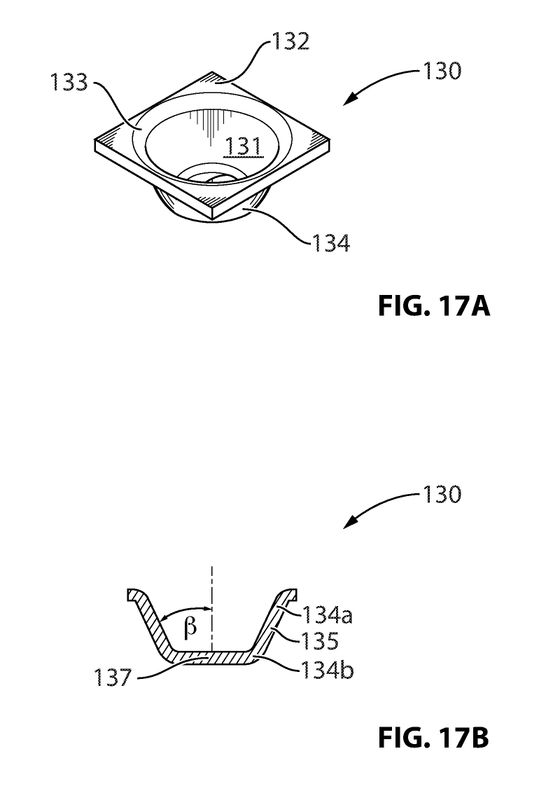

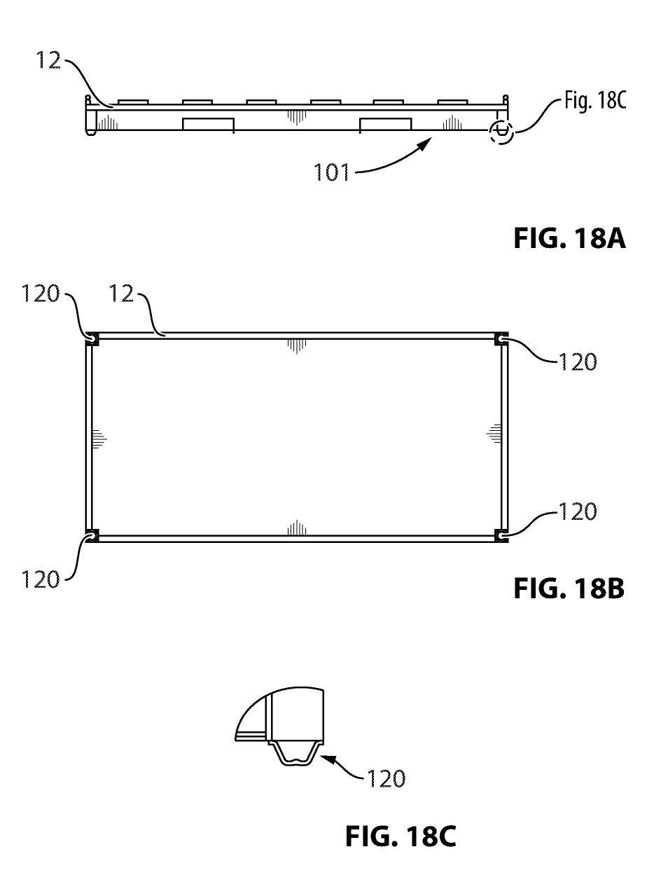

In an alternative embodiment of the present disclosure, a system of corner locators and locks are provided so as to stabilize mini-containers stacked on top of other mini-containers. As illustrated in FIG. 16a, a locating foot 120 comprises a flange 122 adapted for secure attachment to the bottommost surface 101 of base 12, and a foot portion 124 extending outwardly from the flange 122. The foot portion 124 comprises an upper end 124a adjacent the flange 122, and a lower end 124b which is distal the upper end 124a. The foot portion 124 further comprises a wall 125 extending from the upper end 124a towards the lower end 124b and the base 127. Preferably, the geometry of the foot portion 124 is frustoconical, wherein the wider end of the frustoconical geometry of the foot portion 124 is adjacent the flange 122, and the narrower end of the frustoconical geometry is adjacent the base 127. The wall 125 extends from the base 127 towards the flange 122; in one embodiment of the present disclosure, the wall 125 slopes from the base 127 towards the flange 122 at an angle α of 25° from the vertical.

A corresponding receiving cup 130, adapted to slidably mate with the locating foot 120, may be integrally formed with the upper surface of the roof 24 mini container 10. The receiving cup 130 comprises a flange 132 and a cup portion 134 extending inwardly towards the interior of the mini-container 10 and away from the flange 132 of the receiving cup 130. The receiving cup 130 is adapted so as to snugly receive the locating foot 120, wherein the receiving cup 130 may be formed in each of the four corners of the roof 24 of a lower container 10″, and the locating foot 120 may be integrally formed as part of each of the four corners of the upper container 10′.

The embodiment described above is an example only and it is understood by a person skilled in the art that other variations are possible and within the scope of this present disclosure. For example, a plurality of locating feet 120 may protrude from the uppermost surface of the roof 24 and a plurality of receiving cups 130 may be recessed or integrally formed with the bottommost surface 101 of base 12, such that the receiving cups 130 on the base 12 of an upper container 10′ mate with the plurality of locating feet 120 on the roof 24 of a lower container 10″ (not shown).

In an embodiment of the present disclosure, the receiving cup 130 comprises a wall 135 which extends from the upper end 134a adjacent the flange 132, towards a lower end 134b adjacent a base 137 of the cup portion 134. At least the interior surface 131 of cup portion 134 also has a frustoconical geometry, whereby the wall 135 extends at an angle 13 of, for example, 2520 from the vertical, as the wall 135 extends from the base 137 towards the flange 132. The locating foot 120 comprises an exterior surface 121 consisting of the wall 125 and the base 127. The receiving cup 130 comprises an interior surface 131. The interior surface 131 of receiving cup 130 is sized so as to slidably couple with exterior surface 121 of the locating foot 120. The receiving cup 130 may further comprise a lip surface 133 interceding between the flange 132 and the interior surface 131 of the cup portion 134, wherein the lip portion 133 slopes from the planar surface of the flange 132 towards the frustoconical interior surface 131 of the cup portion 134.

In use, there are four locating feet 120, one located in each of the four corners of the bottommost surface 101 of the base 12 of a upper container 10′. A lower container 10″ is provided with a receiving cup 130 formed on the exterior surface 102 of the roof 24 of the lower container 10″, whereby there is a receiving cup 130 located in each of the four corners of the roof 24. Thus, when placing upper container 10′ on top of the lower container 10″, the four locating feet 120 may be slidably translated along the surface 102 of roof 24 of the lower container 10″ until base 127 of at least one of the locating feet 120 on the base 12 of the upper container 10′ encounters at least the lip surface 133 of at least one receiving cup 130, at which point the exterior surface 121 of each of the locating feet 120 will slide into, and mate with, each of the four receiving cups 130 integrally formed in the four corners of the roof 24 of the lower container 10″. As each of the locating feet 120 mate with each of the receiving cups 130, each of the four corners of the base 12 of upper container 10′ are usefully completely aligned with the corresponding four corners of the lower container 10″.

The mating of each of the four locating feet 120 with the corresponding receiving cups 130 serves to substantially prevent the lateral translation of the upper container 10′ relative to the lower container 10″. This arrangement provides for improved locking together of an upper container 10′ stacked on top of a lower container 10″, with the result that the upper container 10′ is much less likely to shift off of the lower container 10″ during transport of multiple stacked containers 10. As a locating foot 120 mates with a receiving cup 130, the lip portion 133, which in one embodiment is angled downward and into the interior surface 131 of the receiving cup 130, the lip portion 130 thus improves the guidance of the locating foot 120 into receiving cup 130.

As also seen in the progression of views in FIGS. 6a-6h, it will be noticed that, in order to provide for the thickness of each panel 16, 18, 20, 22 when the panels are folded down onto base 12, each of the corresponding hinges 26 are at increasingly elevated positions relative to base 12. Thus, in the illustrated embodiment, which is not intended to be limiting, with roof 24 removed (FIG. 6a), because front panel 16 folds down onto base 12 first (FIG. 6b), that is, before the other panels are folded down, the corresponding front hinge 26a is lower most as compared to the elevation of the other hinges, being substantially flush with deck 12c. Because back panel 18 folds down onto front panel 16 (FIG. 6c), the hinge 26 which corresponds to back panel 18, namely, hinge 26b is elevated relative to hinge 26a by the thickness of front panel 16. Hinges 26c, which correspond to right and left panels 20 and 22 respectively, are both at the same elevation relative to base 12 because, when folded down (FIGS. 6d-6g), panels 20 and 22 do not overlap but rather fold down into a co-planar abutting position (FIG. 6g) on panel 18.

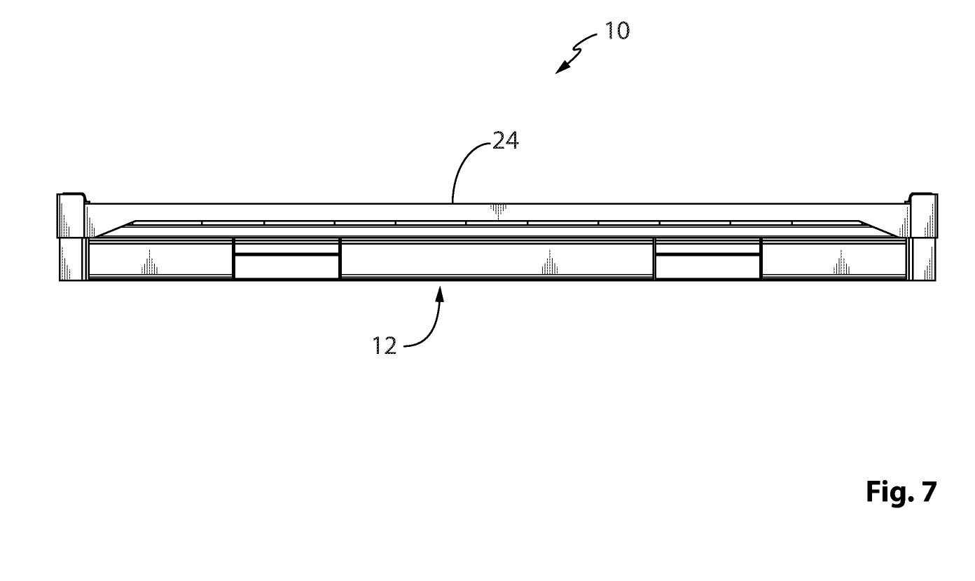

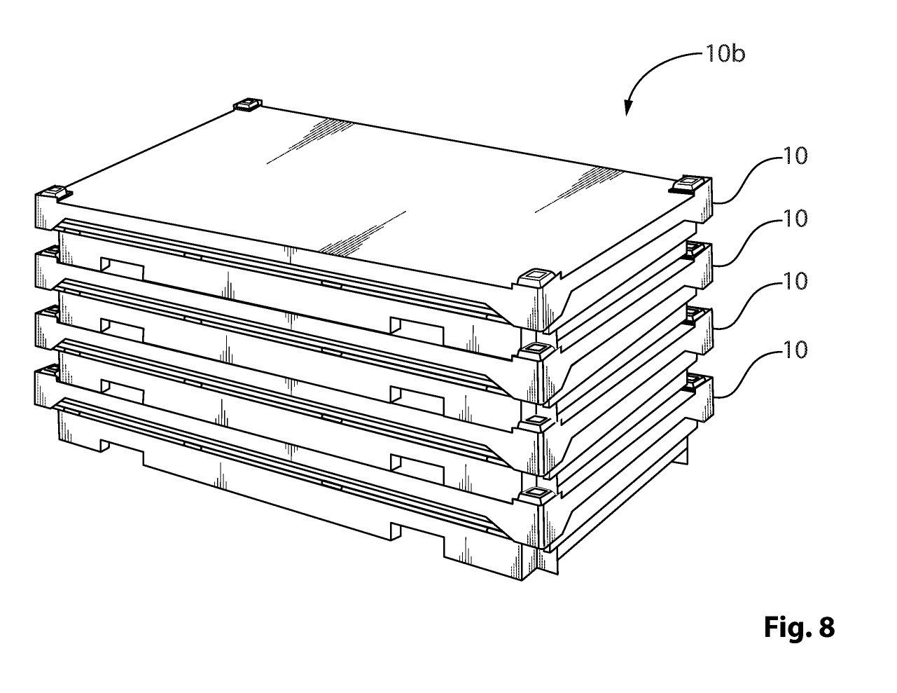

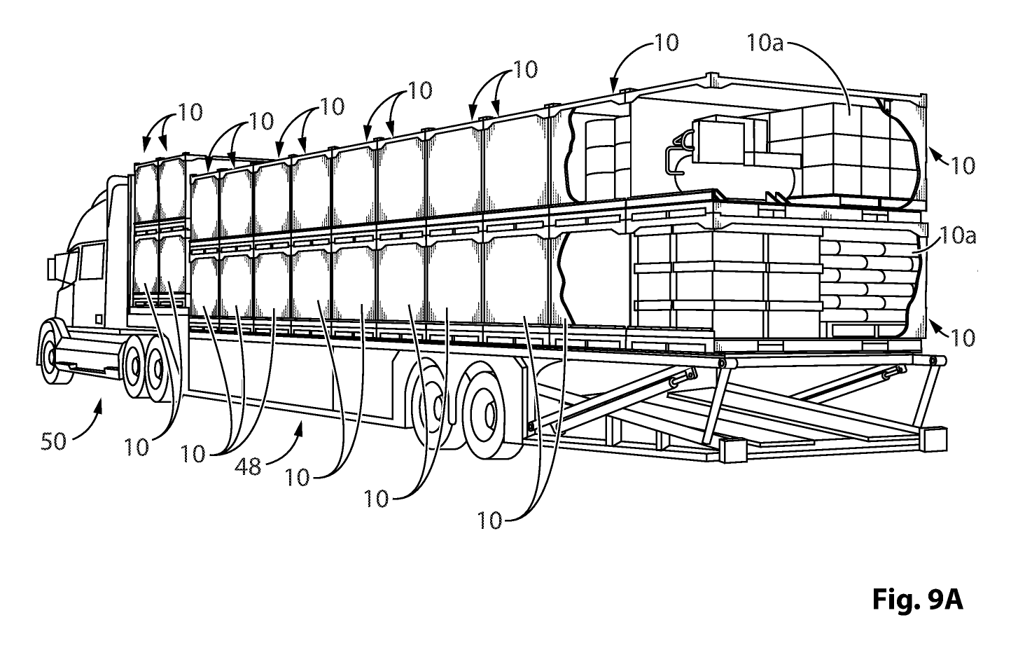

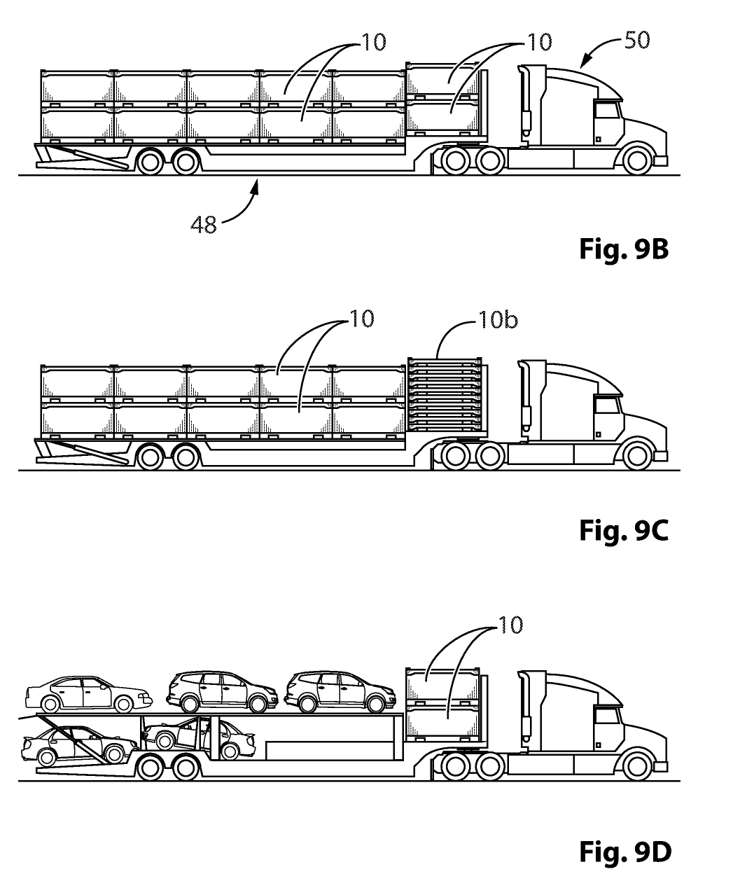

Thus when transitioning from the fully erected position of FIG. 6a to the fully collapsed storage position of FIG. 7, front panel 16 rotates about hinge 26a in direction A, back panel 18 rotates about hinge 26b in direction B, followed by panels 20 and 22 folding down in direction C about their corresponding hinges 26c. Once panels 16-22 are in their fully folded down positions, roof 24 may be positioned as a cover over the folded down panels such as seen in FIGS. 6g, 6h so that rim 24a surrounds the folded down panels and their corresponding hinges 26 to provide an efficient tightly packed and compact package containing mini-container 10 in its storage position while still providing, access to apertures 12a. Thus the collapsed mini-container 10 or the stack 10b may be moved by using a fork lift 14. Notably mini-containers 10 when in their storage position may still be stacked one upon the other by interlocking of hard points 28. Consequently, many mini-containers 10 in their storage position may be carried on a mobile transport conveyor as seen in FIG. 9c in a stack 10b. For example a stack 10b of four mini-containers 10 may only occupy the space of one mini-container 10 in its erected position. This minimizes the penalty to carrying capacity where it is desired to transport mini-containers 10 in their storage position so that they may be erected for use on a return trip of the mobile transport conveyor.

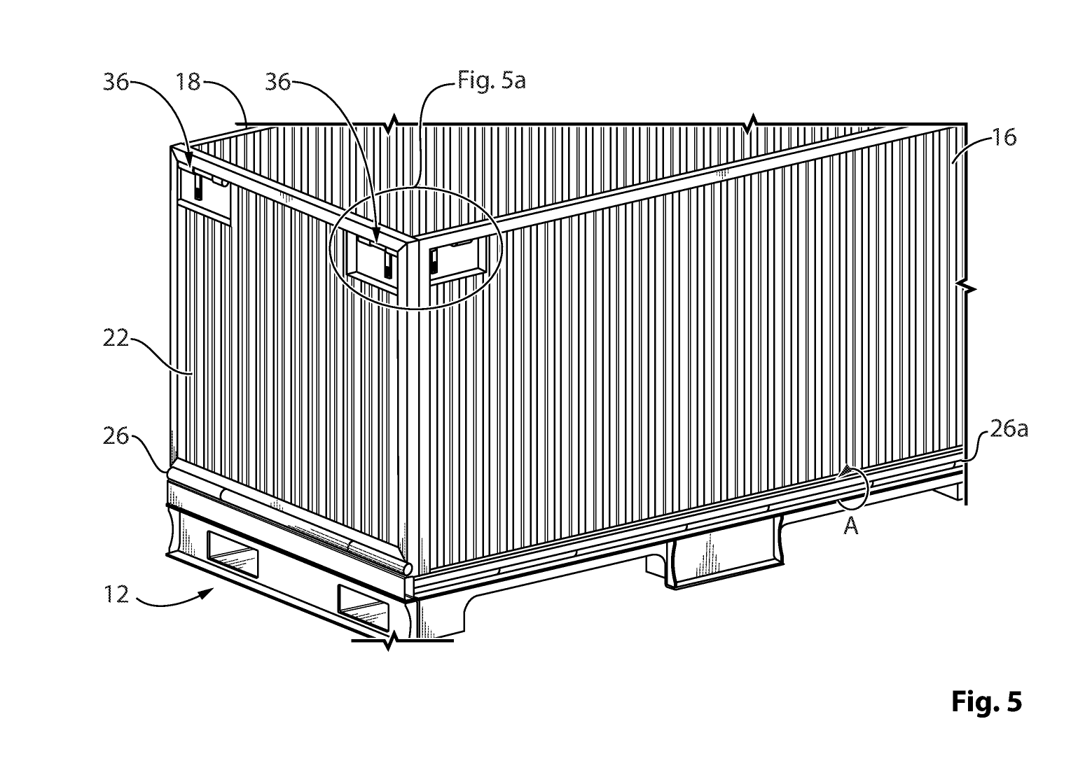

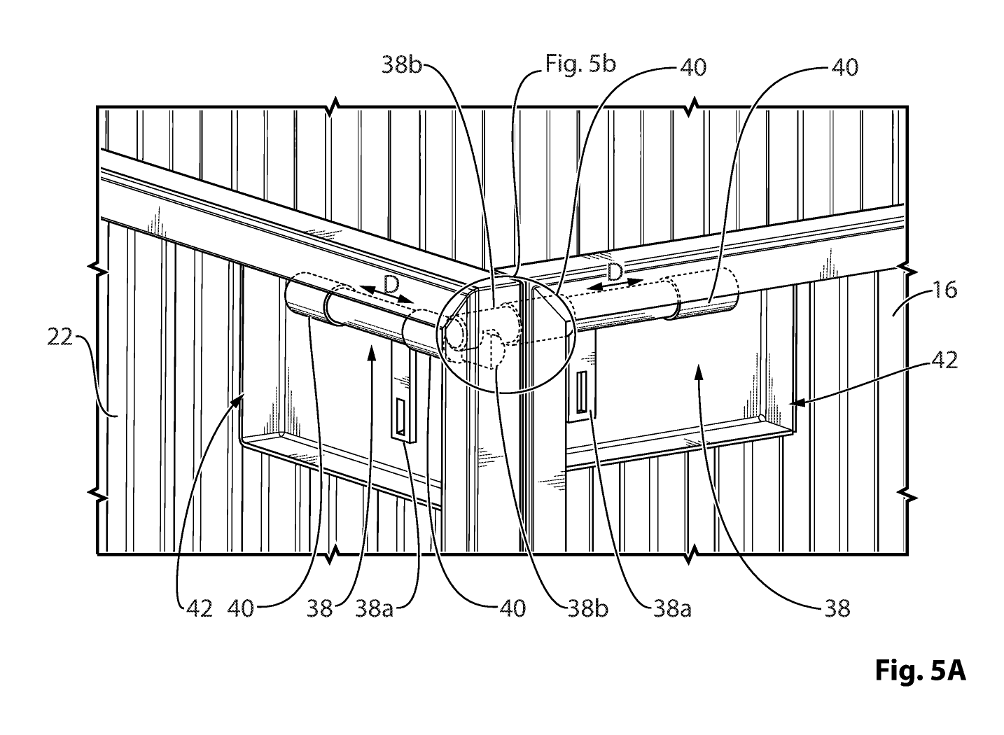

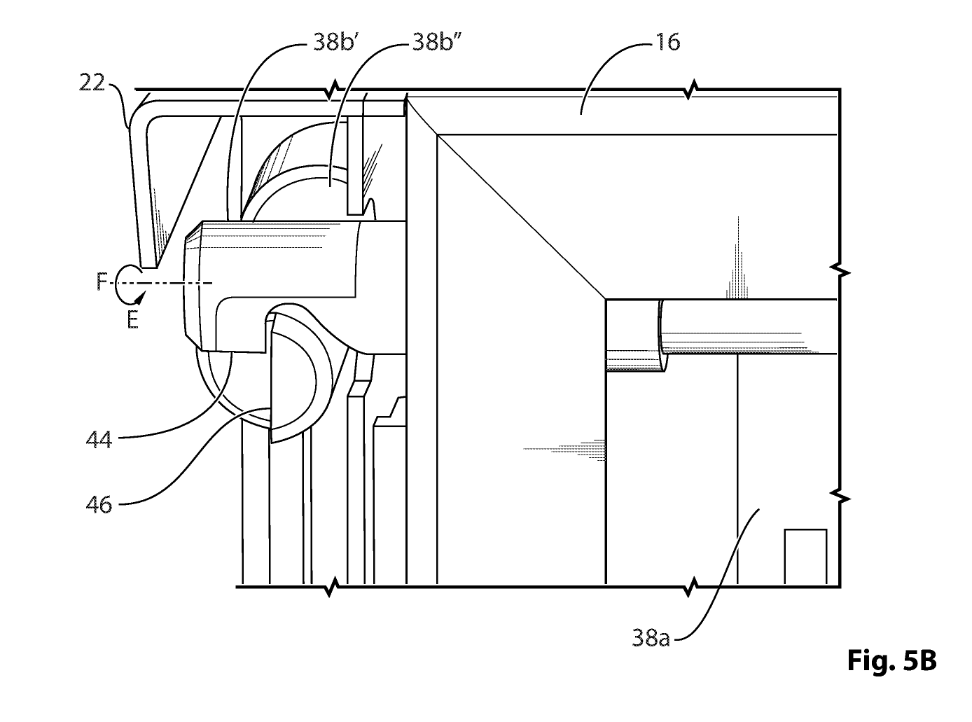

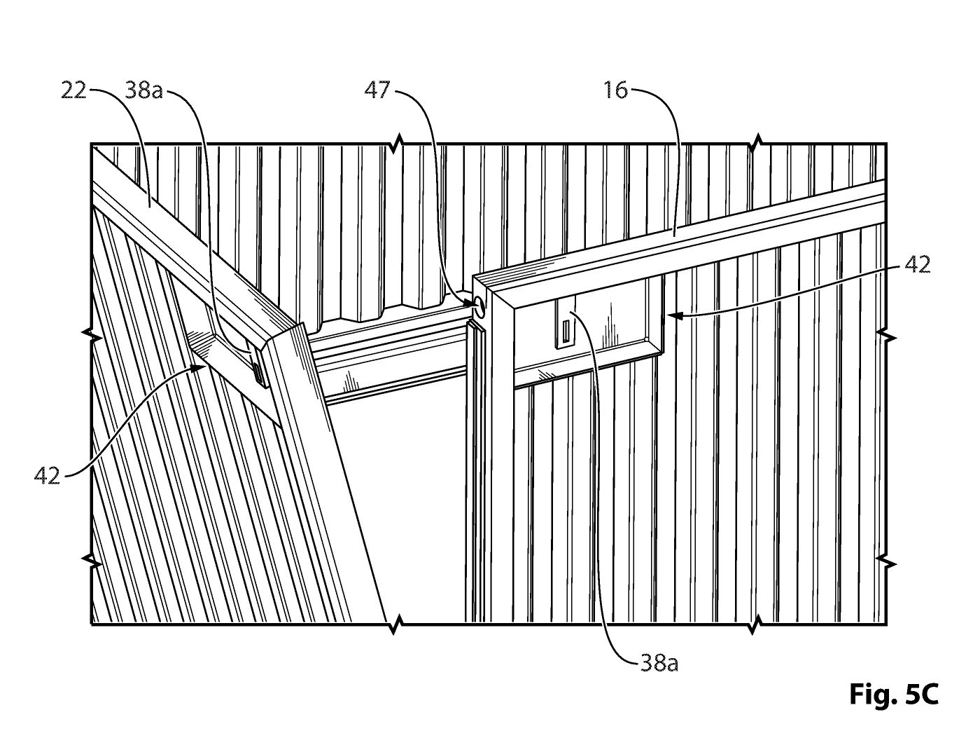

An alternative embodiment of mini-container 10 is shown in FIG. 5 with roof 24 removed, and with panels 16-22 in there erected position. As seen in FIGS. 5a-5c, one manner, not intended to be limiting, of securing the panels 16-22 to each other when in their fully erected position, is the use of interlocking latches 36 at each of the upper four corners of mini-container 10. Thus as seen in FIG. 5, when roof 24 is removed from mini-container 10, the protective cover provided by roof 24 and rim 24a covering over latches 36 is removed thereby exposing access to slide bolts 38. Slide bolts 38 are merely one example of releasable locking of the panels to one another and is not intended to be limiting as other forms of locks, as defined herein, or no locks at all, would also work. Each slide bolt 38 is journaled in a corresponding pair of collars 40 mounted into recesses 42 in corresponding adjacently abutting sides of panels 16-22. Slide bolts 38 are free to slide in direction D, constrained by the movement of slide bolt handle 38a between collars 40. The interlocking ends 38b of each slide bolt 38 releasebly lock against one another when slide bolt handles 38a are in their most closely adjacent position such as seen in FIG. 5a. One interlocking latching mechanism, which is not intended to be limiting, is seen in FIG. 5b wherein a downwardly protruding flange 44 of the upper interlocking end 38b′of the upper slide bolt 38, is rotated downwardly into position by the corresponding rotation of the corresponding slide bolt handle 38a in direction E about axis of rotation F so as to engage flange 44 behind vertical face 46 of the lower interlocking end 38b″ of the lower slide bolt 38.

As seen in FIG. 5c, with the upper interlocking end 38b′ retracted into its corresponding aperture 46, panels 16 and 22 may be rotated away from one another about their corresponding hinges 26. The same latching mechanism may be applied in each of the four corners between the four panels 16-22.

Mini-containers 10 may be loaded onto a standard automobile carrier, or a convertible trailer such for example as described in U.S. Pat. No. 6,497,541, or onto conventional semi -trailers. Mini-containers 10 may also be loaded onto rail cars, ocean vessels, airplanes, or other mobile transport conveyors. Thus the uses of mini-containers 10 provide a multi-modal freight transportation solution. In some applications, not intended to be limiting, such as in hauling automobiles, the use of mini-containers 10 may reduce or substantially eliminate inefficient empty back-hauling of the automobile carrier, thereby potentially increasing profit margins for the hauling enterprise.

When not in use, as seen in FIG. 9c, mini-containers 10 may be stacked in a stack 10b on a convertible trailer 48, for example to occupy the space of two fully erected mini-containers 10.

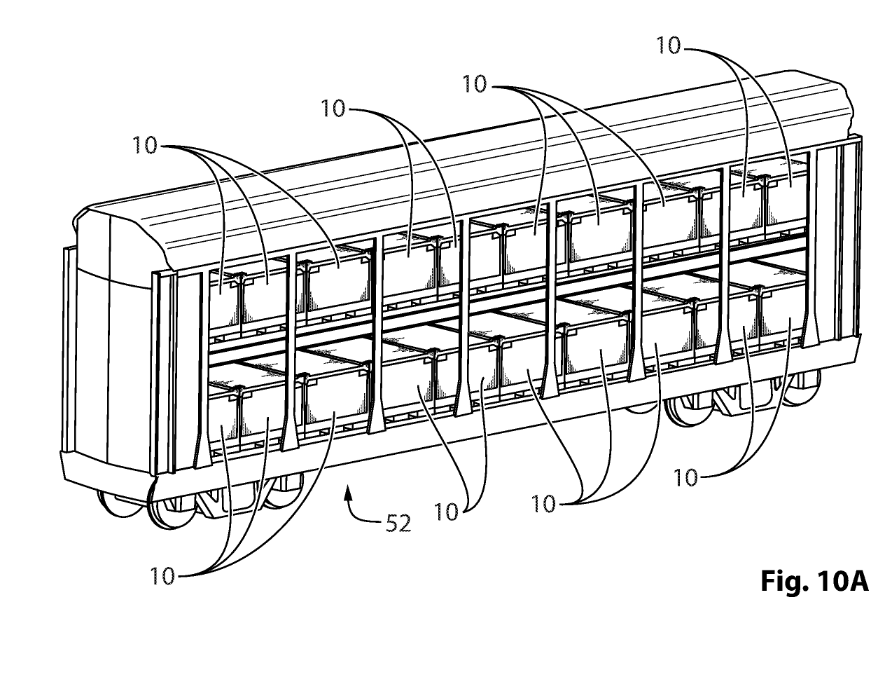

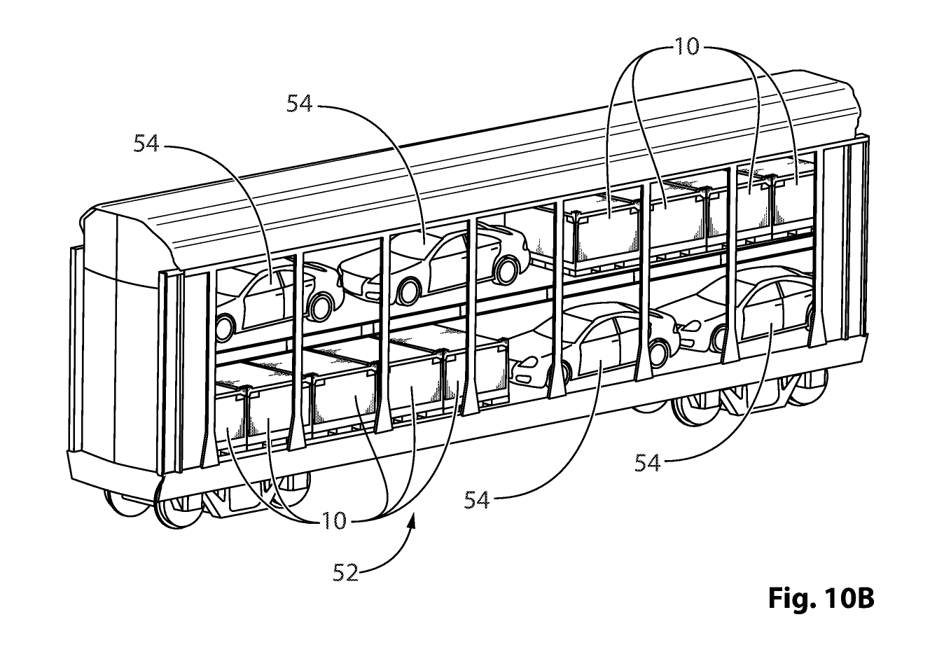

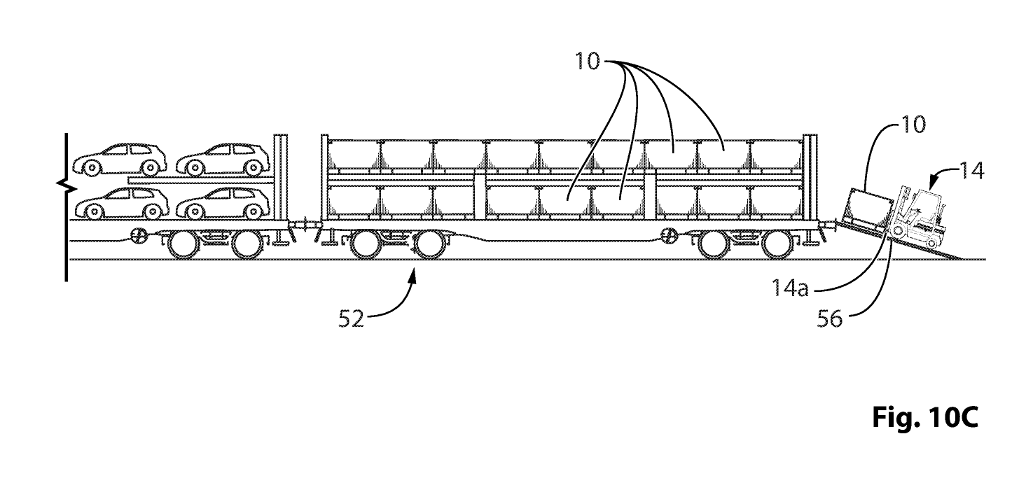

In the illustrated embodiment of FIG. 9a, convertible trailer 48 has twenty mini-container 10 loaded on it, with a further four mini-containers 10 loaded on the elevated front mounted on the load deck behind the cab of tractor 50. Thus it will be understood that access to mini-containers 10 is relatively easy, even in confined space such as illustrated in FIGS. 10a-10c showing the example of a loaded railway car, by the use of a fork lift 14 which may load or unload mini-containers 10 either from the sides or from the ends of the mobile conveyor, for example trailer 48, or tractor 50, or railway car 52, or a ship, boat, barge, airplane, etcetera. Advantageously for these and other applications each mini-container 10 has a storage capacity of for example in the range of approximately 3 square metres (m²) to 31/4 m².

In the illustrated examples of FIGS. 10a-10c, railway car 52 carries for example twenty mini-containers 10. In the example illustrated in FIG. 10b railway car 52 is carrying a mixed load of mini-containers 10 and automobiles 54, for example nine mini-containers 10 and four automobiles 54. It will be understood that the numbers of mini-containers 10 being carried within railway car 52, or for that matter in or on any mobile transport conveyor, may be fewer in number or greater in number depending on how much other types of cargo is also being carried. For example, in the illustrated embodiment, how many automobiles 54 are to be transported simultaneously with mini-containers 10 may be varied depending on demands. Thus as seen in FIG. 12, which illustrates a railway car 52 carrying a full load of mini-containers 10, it will be appreciated that fork lifts 14 may load or unload mini-containers 10 from either end of railway car 52, or may be for some types of railway cars (example flatbed) or other flatbed or open-sided mobile conveyors, forklifts 14 may load mini-containers 10 from the sides.

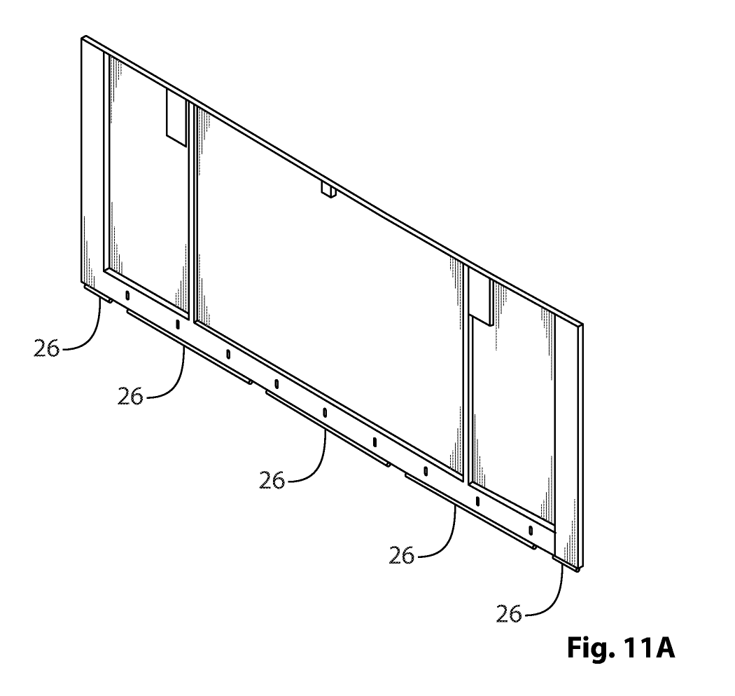

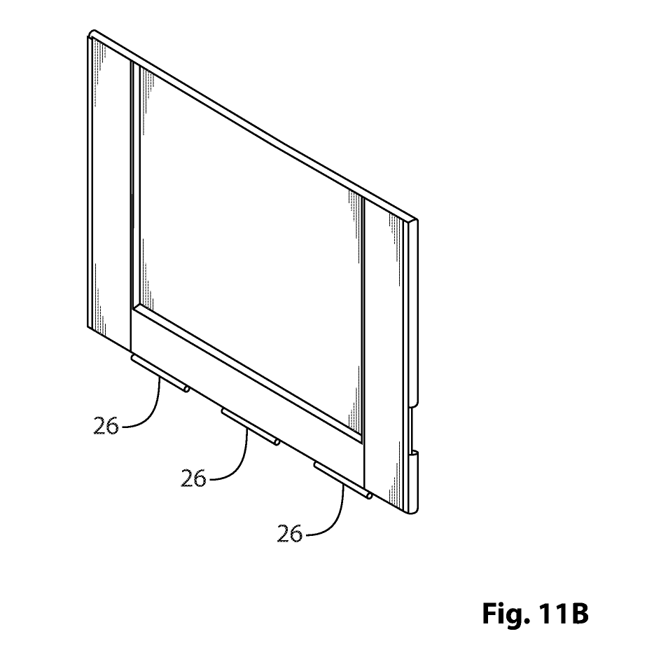

The interior surfaces of the long and short panels of panels 16-22 are shown in FIG. 11a and 11b respectively. Again, these are not intended to be limiting, but show one embodiment of incorporating hinge 26, at least in part, into panels 16-22. Another view of the arrangement of hinges 26 is seen in the elevation view of FIG. 2c. Portions of hinges 26 are also seen protruding, or mounted to, the upper deck of floor of base 12 in FIG. 2a. A cutaway section of a hinge 26 is seen in the view of FIG. 12.

A lifting lug 58 is illustrated in FIG. 13, and shown, respectively, folded down in FIG. 1 so as to be recessed in set-backs 60, and pivoted upwardly for use in FIGS. 1b and 6a for example.

What is claimed is:

1. A mini-container for intermodal shipping comprising a plurality of panels forming a pair of oppositely disposed side panels, a front panel, a back panel opposite to said front panel, a base, and a roof, wherein said side, front and back panels, when erected on said base form an enclosure of said mini-container, and wherein said panels are configurable between an erected-for-use configuration wherein they are releasably mounted to one another to form a box on said base, and a collapsed storage configuration wherein said side, front and back panels are stacked, lying flat relative to one another to form a stack of said panels laying on said base and wherein in said storage configuration said stack is overlaid with said roof.

2. The mini-container of claim 1 wherein each mini-container has an in-use length dimension and an in-use width dimension wherein when the mini-container is in the erected-for-use configuration, said in-use length and width dimensions are sized so as to contain a load selected from a group comprising at least two pallets and at least three boxes, wherein the at least two pallets or at least three boxes are positioned side-by-side and adjacent the base of the mini-container.

3. The mini-container of claim 2 wherein each pallet of the at least two pallets having dimensions selected from a group comprising:
a) a length of substantially 1200 mm and a width of substantially 1000 mm,
b) a length of substantially 1219.2 mm and a width of substantially 1143 mm.

4. The mini-container of claim 2 wherein each box of the at least three boxes having a length of substantially 1200 mm and a width of substantially 800 mm.

5. The mini-container of claim 1 wherein said base comprises a plurality of feet protruding from said base and said roof comprises a corresponding plurality of cups recessed into said roof, wherein said plurality of feet on a base of a first mini-container couples with said corresponding plurality of cups on a roof of a second mini-container when the base of the first mini-container is stacked on top of and adjacent to the roof of the second mini-container.

6. The mini-container of claim 5 wherein said plurality of feet comprises at least one foot located proximal a corner of said base and wherein said plurality of cups comprises at least one cup located proximal a corner of said roof, wherein said corner of said base of said first mini-container is adjacent said corner of said roof of said second mini-container when the base of the first mini-container is stacked on top of and adjacent to the roof of the second mini-container.

7. The mini-container of claim 1 wherein said roof comprises a plurality of feet protruding from said roof and said base comprises a corresponding plurality of cups recessed into said base, wherein said plurality of feet on a roof of a first mini-container couples with said corresponding plurality of cups on a base of a second mini-container when the base of the second mini-container is stacked on top of and adjacent to the roof of the first mini-container.

8. The mini-container of claim 7 wherein said plurality of feet comprises at least one foot located proximal a corner of said roof and wherein said plurality of cups comprises at least one cup located proximal a corner of said base, wherein said corner of said roof of said first mini-container is adjacent said corner of said base of said second mini-container when the base of the second mini-container is stacked on top of and adjacent to the roof of the first mini-container.

9. The mini-container of 5, 6, 7 and 8 wherein each foot of said plurality of feet and each cup of said corresponding plurality of cups has frustoconical geometry.

10. A method of intermodal shipping using the mini-containers of claim 1 comprising:
a) providing a plurality of the mini-containers of claim 1, wherein each mini-container of said plurality of mini-containers is assembled from said panels so as to form said pair of oppositely disposed side panels, a front panel, a back panel opposite to said front panel, a base, and a roof, wherein said side, front and back panels releasably mount to another to form an enclosure of said mini-container and release from one another for positioning between said erected-for-use configuration and said collapsed storage configuration,
b) providing a mobile transport conveyor having at least one loading bed,
c) constructing each said mini-container of said plurality of mini-containers into said erected-for-use configuration, and storing cargo into said constructed plurality of mini-containers when in said erected-for-use configuration,
d) loading said plurality of mini-containers containing said cargo on to said at least one bed of said mobile transport conveyor, wherein said mobile conveyor transport is chosen from the group comprising: a trailer, an automobile transport trailer, a convertible transport trailer, a flatbed trailer, an enclosed van trailer, a curtain-side trailer, a railwaycar, a flatbed railwaycar, a ship, a barge, an airplane.

11. The method of claim 10 wherein each mini-container has an in-use length dimension and an in-use width dimension wherein when the mini-container is in the erected-for-use configuration, said in-use length and width dimensions are sized so as to contain a load selected from a group comprising at least two pallets and at least three boxes,
wherein the at least two pallets or at least three boxes are positioned side-by-side and adjacent the base of the mini-container.

12. The method of claim 11 wherein each pallet of the at least two pallets having dimensions selected from a group comprising:
a) a length of substantially 1200 mm and a width of substantially 1000 mm,
b) a length of substantially 1219.2 mm and a width of substantially 1143 mm.

13. The method of claim 11, wherein each box of the at least three boxes having a length of substantially 1200 mm and a width of substantially 800 mm.
